(19) United States
(12) Patent Application Publication
(10) Pub. No.: US 2026/0360866 A1
(43) Pub. Date: Nov. 12, 2026

(54) CURTAILING BATTERY INSTABILITY

(71) Applicant: Enovix Corporation, Fremont, CA (US)

(72) Inventors: Benjamin Ian HSIA, Fremont, CA (US); Michael ARMSTRONG, New Braunfels, TX (US)

(21) Appl. No.: 19/733,581

(22) Filed: Jul. 7, 2026

Related U.S. Application Data
(63) Continuation of application No. PCT/US2025/010475, filed on Jan. 6, 2025.
(60) Provisional application No. 63/618,675, filed on Jan. 8, 2024.

(51) Int. Cl. H01M 10/659; H01M 10/637

(52) U.S. Cl. CPC H01M 10/659; H01M 10/637; H01M 2200/10

(57) ABSTRACT

The present inventions relate to methods, systems, apparatuses, controllers, software, and composition of matter associated with curtailing (e.g., preventing) adverse effect(s) relating to a battery cell such as occurring during its lifetime. The adverse effects may be associated with a triggering event (e.g., a melting temperature) affecting at least one material of the battery cell, or of a battery comprising the battery cell. The at least one material may be an insulating material.

### PRIORITY

This application claims priority to International Patent Application Serial No. PCT/US25/10475, which claims priority to U.S. Provisional Patent Application Ser. No. 63/618,675 filed on Jan. 8, 2024, each of which is incorporated herein by reference in its entirety.

### BACKGROUND

The present inventions relate to methods, systems, apparatuses, controllers, software, and composition of matter, e.g., materials. The present inventions relate to structures for use in energy manipulation (e.g., energy storage and/or energy release) devices comprising a battery cell (also referred to herein as “cell”), e.g., disposed in a battery. In an example, the present inventions relate to structures such as electrode assemblies for use in energy manipulation devices, such as (e.g., secondary) batteries. The present inventions relate to energy manipulation (e.g., energy storage) devices employing such structures. The present inventions relate to (e.g., methods for) manufacturing such structures and/or energy devices. In an example, the present invention relates to methods and structures such as electrode assemblies for use in energy manipulation (e.g., energy storage) devices such as secondary batteries, to energy manipulation (e.g., energy storage) devices employing such structures, and to methods for manufacturing such structures and energy devices.

In some cases, there may be shortcoming(s) related to such batteries, their use, their storage, their maintenance, and/or their manufacture, e.g., the process of making such batteries. In an example, there are a number of shortcomings related to batteries and the process of making them. A problem occurring in the energy manipulation (e.g., energy storage) device (e.g., battery) is its heating, e.g., due to battery abuse. The battery abuse may comprise thermal, electrical, or mechanical abuse resulting in the temperature increase. The temperature increase may occur at least in part due to increased electrical current between two opposing electrodes of a cell, e.g., at least in part due to a short. In normal operation of a cell, current passes from one electrode to its opposing electrode, mainly through a separation space between then, the separation space contacting the two opposing faces of the batteries. There may be a residual current passing through a volume contacting one or more sides of the two opposing electrodes. The increased heat may be at least in part due to Joule heating. Such heating may cause adverse effects to the energy manipulation (e.g., energy storage) device and/or its surroundings. The adverse effect may be at least in part due to instability of a cell of the battery and/or of the battery. Such heating may be caused by increased current between the opposing electrodes. Such heating may be generated during a thermal runaway reaction, e.g., an uncontrollable chain reaction. Such heating may be generated in the battery at a rate exceeding the battery heat dissipation rate. The fast-increasing heat may cause a chemical (e.g., exothermic) reaction, generating additional heat. Such heat may cause adverse effects comprising release of toxic gas, fire, or explosion. The adverse effect(s) may be adverse to the cell, to the battery, and/or objects disposed in the environment outside of the cell, whether animate or inanimate. Outside of the cell can comprise outside of the battery housing, e.g., in an ambient environment. The adverse effects may be defined according to jurisdictional definition in the jurisdiction in which the battery is manufactured, stored, used, and/or otherwise located in. It may be advantageous to curtail (e.g., prevent) the occurrence of such adverse effect(s).

### SUMMARY

In some aspects, the present disclosure resolves one or more of the aforementioned hardships. In some embodiments, the present disclosure provides solutions to curtail the adverse effects. In some embodiments, the present inventions relate to method(s) (e.g., technique), device(s), apparatus(es), system(s), and design(s), which build a battery comprising cell(s). The battery may be configured to curtail the adverse effects, e.g., at least in part by shutting of the residual current and/or the load current which is in normal operation the main current of the battery. In an example, the cell may contact a dynamic insulator having a susceptibility to a triggering event such as reaching a temperature threshold. The triggering event may trigger material change(s) in the dynamic insulator that curtail(s) the rise in temperature of the cell (and/or of the battery), the rate of charge carrier flowing through the dynamic insulator, the concentration of the charge carriers in the dynamic insulator, or any combination thereof. In an example, at least one material type of the dynamic insulator may be susceptible to a triggering event. The triggering event may cause a substantial (e.g., material) change in (i) the flow rate and/or (i) the concentration of, the charge carriers in the dynamic insulator. The susceptibility of the at least one material type may depend at least in part on (a) a temperature threshold, (b) a concentration threshold of the charge carriers, or (c) a flow rate of the charge carriers. In an example, the cell may contact a dynamic insulator having at least one temperature susceptible material that curtails (e.g., prevents) flow of the residual current based at least in part of the temperature of the dynamic insulator. Such (e.g., temperature related) event triggering property/properties of the dynamic insulator may induce a substantial reduction and/or shutdown in the residual current pathway otherwise passing through the dynamic insulator and between the opposing electrodes of a cell. Such curtailing of residual current may (a) reduce the overall (e.g., Joule and/or other) heating of the cell during the adverse effect, and/or (b) reduce the extent of the runaway reaction, e.g., during an external short circuit. Such curtailing of the residual current flow may improve the overall safety of the battery.

In another aspect, a device for energy manipulation, the device comprises: a reference electrode having a reference surface comprising a first reference face opposing to a second reference face, and a first reference side opposing to a second reference side; a counter electrode to the reference electrode, the counter electrode having a counter surface comprising a first counter face opposing to a second counter face, and a first counter side opposing to a second counter side; a separation space comprising a separator disposed between the reference electrode and the counter electrode, the separation space having a separation surface comprising a first separation face opposing to a second separation face and a first separation side opposing to a second separation side, the first separation face contacting the second reference face, and the second separation face contacting the first counter face; and at least one insulator occupying an insulating volume, the at least one insulator contacting (a) the first reference side, the first counter side, and the first separation side, (b) the second reference side, the second counter side, and the second separation side, or (c) a combination of (a) and (b), the at least one insulator comprising at least one material type susceptible to a triggering event indicative of at least one adverse effect to the device and/or to a surrounding of the device, the at least one material type being configured to alter one or more properties of the at least one material type based at least in part on occurrence of the triggering event, the at least one insulator being dynamic at least in part with respect to the triggering event, the device being configured for flow of an electrical current, the flow being between the reference electrode and the counter electrode. In some embodiments, the at least one insulator is an electric insulator, e.g., configured to conduct electrical current poorly under normal operating conditions such as excluding the triggering event. In some embodiments, the triggering event relates to an uncontrollable reaction resulting in the at least one adverse effect. In some embodiments, the triggering event relates to a runaway reaction. In some embodiments, the triggering event relates to initiation of the runaway reaction. In some embodiments, the triggering event occurs at least in part in the at least one insulator, the triggering event comprising a threshold, the threshold being of an attribute comprising a temperature, electrical current flowing, or a concentration of ions. In some embodiments, the flow of the electrical current in the device comprises a load current and a residual current. In some embodiments, the device is configured to flow the load current from the second reference face to the first counter face and/or from the first counter face to the second reference face, the load current flowing through the separation space. In some embodiments, the device is configured to flow the residual current from the second reference face to the first counter face and/or from the first counter face to the second reference face, the residual current flowing through the at least one insulator. In some embodiments, the triggering event comprises a melting point, or a glass transition. In some embodiments, upon the occurrence of the triggering event, the at least one material type is configured to transition such that the at least one adverse effect will be curtailed, become controllable, or any combination thereof, with curtailed comprising effectively ceased or measurably ceased. In some embodiments, upon the occurrence of the triggering event, the at least one material type is configured to transition such that heat generated will equate, or substantially equate, the heat generated in the device. In some embodiments, upon occurrence of the triggering event, the at least one material type is configured to transition such that a propagation of ions therethrough, will be curtailed comprising will lessen, will effectively cease, or will measurably cease. In some embodiments, upon occurrence of the triggering event, the at least one material type is configured to transition such that the electrical current flowing through the at least one insulator, will be curtailed comprising will lessen, will effectively cease, or will measurably cease. In some embodiments, upon the occurrence of the triggering event, the at least one material type is configured to transition such that the electrical current flowing respectively therethrough, will be curtailed comprising will lessen, will effectively cease, or will measurably cease. In some embodiments, upon the occurrence of the triggering event, the at least one material type is configured to transition from a harder material to a softer material. In some embodiments, the softer material comprises a flowing (e.g., liquid) material. In some embodiments, upon occurrence of the triggering event, the at least one material type is configured to transition comprising to connect. In some embodiments, to connect comprises to melt, to fuse, to sinter, or otherwise to bind. In some embodiments, upon occurrence of the triggering event, the at least one material type is configured to transition from a softer material to a harder material. In some embodiments, (i) the softer material comprising a flowing material, (ii) the harder material comprising a gel, or (iii) a combination of (i) and (ii). In some embodiments, upon occurrence of the triggering event the at least one material type is configured to transition from a liquid to a gel. In some embodiments, the separator is configured to allow flow of the electrical current therethrough at least in part by allowing ions to propagate through pores of the separator. In some embodiments, the at least one material type is at least one first material type; and wherein the separation space comprises at least one second material type configured to curtail electrical flow through the separation space at least in part due to the triggering event occurring in the separation space, and wherein the first material type and/or the second material type, is susceptible to the triggering event. In some embodiments, the first material type is the second material type. In some embodiments, the first material type is different from the second material type by at least one physical and/or chemical property. In some embodiments, the first material type comprises a particulate material. In some embodiments, the second material type comprises a sheet, or a matrix; and wherein a volume occupied by the second material type is a volume of the separation space. In some embodiments, upon occurrence of the triggering event, (i) the first material type, (ii) the second material type, or (iii) a combination of (i) and (ii), is configured to transition such that the at least one adverse effect will be curtailed comprising will lessen, will effectively cease, or will measurably cease. In some embodiments, upon occurrence of the triggering event, (i) the first material type, (ii) the second material type, or (iii) a combination of (i) and (ii), is configured to transition such that heat generated will equate, or substantially equate, the heat generated in the device. In some embodiments, upon occurrence of the triggering event, (i) the first material type, (ii) the second material type, or (iii) a combination of (i) and (ii), is configured to transition such that a propagation of ions (e.g., metal cations such as Li⁺) therethrough, will be curtailed comprising will lessen, will effectively cease, or will measurably cease. In some embodiments, upon occurrence of the triggering event, (i) the first material type, (ii) the second material type, or (iii) a combination of (i) and (ii), is configured to transition such that the electrical current flowing respectively therethrough, will be curtailed comprising will lessen, will effectively cease, or will measurably cease. In some embodiments, upon occurrence of the triggering event, (i) the first material type, (ii) the second material type, or (iii) a combination of (i) and (ii), is configured to transition such that the electrical current flowing respectively therethrough, will be curtailed comprising will lessen, will effectively cease, or will measurably cease. In some embodiments, upon occurrence of the triggering event, (i) the first material type, (ii) the second material type, or (iii) a combination of (i) and (ii), is configured to transition from a harder material to a softer material. In some embodiments, the softer material comprises a flowing material. In some embodiments, upon occurrence of the triggering event, (i) the first material type, (ii) the second material type, or (iii) a combination of (i) and (ii), is configured to transition comprising connect. In some embodiments, connect comprises melt, fuse, sinter, or otherwise bind. In some embodiments, upon occurrence of the triggering event, (i) the first material type, (ii) the second material type, or (iii) a combination of (i) and (ii), is configured to transition from a softer material to a harder material. In some embodiments, the softer material comprising a flowing material, the harder material comprising a gel. In some embodiments, upon occurrence of the triggering event the first material type and/or the second material type, is configured to transition from a liquid to a gel upon occurrence of the triggering event. In some embodiments, the at least one material type comprises an electrolyte. In some embodiments, the at least one insulator is an insulator contacting (a) the first reference side, the first counter side, and the first separation side and (b) the second reference side, the second counter side, and the second separation side. In some embodiments, the at least one insulator comprises a first insulator and a second insulator, the first insulator contacting (i) the first reference side, (ii) the first counter side, and (iii) the first separation side, and the second insulator contacting (iv) the second reference side, (v) the second counter side, and (vi) the second separation side. In some embodiments, the reference electrode is elongated, the reference electrode having a long axis having a first end at the first reference side opposing to a second end at the second reference side, the long axis being a length of the reference electrode, the reference electrode having a short axis having a third end at the first reference face opposing to a fourth end at the second reference face, the short axis being a width of the reference electrode, and wherein an aspect ratio of the width to the length being at least about 1:8, 1:15, or more. In some embodiments, the counter electrode is elongated, the counter electrode having a long axis having a first end at the first counter side opposing to a second end at the second counter side, the long axis being a length of the counter electrode, the counter electrode having a short axis having a third end at the first counter face opposing to a fourth end at the second counter face, the short axis being a width of the counter electrode, and wherein an aspect ratio of the width to the length being at least about 1:8, 1:15, or more. In some embodiments, the separation space is elongated, the separation space having a long axis having a first end at the first counter side opposing to a second end at the second counter side, the long axis being a length of the separation space, the separation space having a short axis having a third end at the first counter face opposing to a fourth end at the second counter face, the short axis being a width of the separation space, and wherein an aspect ratio of the width to the length being at least about 1:8, 1:15, or more. In some embodiments, the reference electrode comprises one or more types of metal oxide. In some embodiments, the counter electrode comprises an allotrope of elemental carbon, or silicon. In some embodiments, the allotrope of elemental carbon comprises graphite, carbon fiber, graphene, carbon nanotube, amorphous carbon, or fullerene. In some embodiments, the reference electrode is smaller than the counter electrode in at least one (e.g., cartesian) direction. In some embodiments, the device is configured such that during use of the device, the reference electrode expands less than the counter electrode. In some embodiments, the device is configured such that during use of the device, a volume of an electrode and/or of the device, expands by at most about 10%, 20%, 30%, 35%, 40%, or 50%, the electrode comprising the reference electrode, the counter electrode, and the separation space. In some embodiments, the device is configured such that during use of the device, a volume of an electrode and/or of the device, expands by at most about 35%. In some embodiments, a battery cell comprises the reference electrode, the counter electrode, and the separation space, the battery cell has a stacking axis along which faces are stacked, the faces comprising the first reference face, the first counter face, and the first separation face. In some embodiments, the stacking axis divides symmetrically each of the faces. In some embodiments, the battery cell comprises cell sides, the cell sides comprising a first cell side or a second cell side, wherein each of the cell sides comprises a misalignment; wherein the first cell side comprises (i) the first reference side, (ii) the first counter side, and (iii) the first separation side; and wherein the second cell side comprises (a) the second reference side, (b) the second counter side, and (c) second first separation side. In some embodiments, the misalignment constitutes a wave. In some embodiments, the misalignment is due to an interlaced longer and shorter side portions of components of the battery cell, the components comprising the reference electrode, the counter electrode, and the separation space. In some embodiments, at least one component of the device comprises a composite material, the at least one component comprising the reference electrode, the counter electrode, the separation space, or the at least one insulator. In some embodiments, the at least one component comprises at least one dividing space contacting the reference electrode and/or the counter electrode. In some embodiments, a battery cell comprises the reference electrode, the counter electrode, the separation space, and wherein the device is a battery comprising a cell set comprising two or more of the battery cell. In some embodiments, in the battery, each of the two or more of the battery cell are separated by a dividing space. In some embodiments, the dividing space and the separation space comprise the same, or substantially the same at least one material type. In some embodiments, the dividing space, the separation space, and the at least one insulator, have at least one material type that is the same. In some embodiments, the dividing space, the separation space, and the at least one insulator, have at least one material type that is different. In some embodiments, a partition space extends beyond (A) a reference face along a reference long axis of the reference face, the reference face comprising the first reference face or the second reference face and (B) a counter face along a counter long axis of the counter face, the counter face comprising the first counter face or the second counter face, the partition space comprising the dividing space or the separation space; and wherein the partition space extends along a long axis by an extension comprising a separation extension or a divider extension, the long axis comprising the reference long axis or the counter long axis. In some embodiments, (i) the divider extension and (ii) the separation extension, are separated from each other by a gap, the divider extension and the separation extension being at a side of the battery cell. In some embodiments, the divider extension is bent towards, or is bent away from, the separation extension. In some embodiments, the divider extension is curved towards, or is curved away from, the separation extension. In some embodiments, a volume disposed between the divider extension and the separation extension, comprises at least a portion of the at least one insulator. In some embodiments, in the battery, the two or more of the battery cell are connected in parallel. In some embodiments, in the battery, the two or more of the battery cell are connected in series. In some embodiments, in the battery, the two or more of the battery cell are stacked along a stacking axis normal, or substantially normal, to (i) the first reference face, (ii) the second reference face, (iii) the first separation face, (iv) the second separation face, (v) the first counter face, (vi) the second counter face, or any combination thereof. In some embodiments, the battery comprises a brace configured to curtail expansion of the battery at least along the stacking axis. In some embodiments, the battery comprises a brace configured to curtail expansion of the battery unevenly along the stacking axis, and along a direction normal to the stacking axis. In some embodiments, the battery comprises a brace configured to curtail expansion of the battery along the stacking axis more than along a direction normal to the stacking axis. In some embodiments, more is by at least about 10%, 20%, or 30% more. In some embodiments, the cell set comprises a first cell side opposing to a second cell side; wherein the first cell side comprises the first reference side, the first separation side, and the first counter side; and wherein the second cell side comprises the second reference side, the second separation side, and the second counter side. In some embodiments, the at least one insulator contacts the first cell side and the second cell side. In some embodiments, the at least one insulator comprises a first insulator and a second insulator; wherein the first insulator contacts the first cell side; and wherein the second insulator contacts the second cell side. In some embodiments, (I) the first cell side runs along a direction of the stacking axis, and parallel, or substantially parallel, to the stacking axis, (II) the second cell side runs along a direction of the stacking axis, and parallel, or substantially parallel, to the stacking axis, and (III) a combination of (I) and (II). In some embodiments, (a) the first cell side is corrugated, and/or (b) the second cell side is corrugated. In some embodiments, each of the two or more of the battery cells has the reference electrode coupled with a reference current collector; wherein each of the two or more of the battery cell has the counter electrode coupled with a counter current collector; wherein each of the reference current collector is coupled with a main reference current collector; and wherein each of the counter current collector is coupled with a main counter current collector. In some embodiments, the main reference current collector and the main counter current collector, are disposed on one side of the cell set adjacent to a cell side including the first cell side or the second cell side. In some embodiments, the main reference current collector and the main counter current collector, are each disposed on opposing sides of the cell set each of the opposing sides being adjacent to a cell side including the first cell side or the second cell side, respectively. In some embodiments, the battery has a XY face type, a YZ face type, and a XZ face type; wherein a stacking direction of the cell is along an X direction; and wherein the XY face type has a surface area (i) larger than the surface area of the YZ face type, and (ii) larger than the XZ face type. In some embodiments, a cell side of the cell set faces the XY face type, the cell side comprises the first cell side or the second cell side. In some embodiments, the device is configured for utilization in an electronic device comprising a wireless device. In some embodiments, the device is configured for utilization in an electronic device comprising a controlling device. In some embodiments, the device is configured for utilization for leisure or for work. In some embodiments, the device is configured for utilization in an electronic device comprising a phone, a laptop, a computer pad, a console, a computer mouse, a wearable device, or a toy. In some embodiments, the device is configured for utilization in a vehicle. In some embodiments, the vehicle comprises a car, an aircraft, a ship, a train, or a spacecraft. In some embodiments, the spacecraft is unmanned. In some embodiments, the spacecraft is manned. In some embodiments, the aircraft comprises a drone or an airplane. In some embodiments, the device is configured for utilization in a medical setting. In some embodiments, the device is configured for administration of an electrical current to a subject. In some embodiments, the subject is an animated subject. In some embodiments, the administration of an electrical current is for medical or other lifesaving purposes. In some embodiments, the device is configured for utilization in an environment hostile to an animated subject. In some embodiments, the device is configured for utilization in an environment agreeable to an animated subject.

In another aspect, a method for energy manipulation in the device, the method comprises: (a) providing any of the above devices, and (b) storing the device, maintaining the device, transporting the device, pre-charging the device, or using the device for the energy manipulation while curtailing the at least one adverse effect.

In another aspect, an apparatus for energy manipulation in the device, the apparatus comprises: at least one controller configured (a) for operatively coupling with any of the above devices, and (b) executing, or directing execution of, at least one component of the device to execute one or more operations associated with the energy manipulation, while curtailing the at least one adverse effect. In some embodiments, the at least one controller is configured to operatively couple to a power source and/rot with a communication platform.

In another aspect, one or more non-transitory computer readable media comprising program instruction physically inscribed thereon, the program instructions, when read by one or more processors operatively coupled with one or more components of any of the above devices, are configured to execute, or direct execution of, one or more operations associated with the energy manipulation, while curtailing the at least one adverse effect.

In another aspect, a method for fabricating the device for energy manipulation, the method comprises: (a) depositing the at least one insulator onto a battery cell to fabricate any of the above devices, the battery cell comprising (i) the reference electrode, the counter electrode, and the separation space. In some embodiments, depositing the at least one insulator includes using a method comprising printing, stenciling, or heat transfer. In some embodiments, during deposition of the at least one insulator onto the battery cell, the at least one insulator is in a flowable form. In some embodiments, the flowable form comprises a slurry or a spray.

In another aspect, an apparatus for energy manipulation in the device, the apparatus comprises: at least one controller configured execution, or directing execution of, one or more operations to effectuate any of the above methods to fabricate the device. In some embodiments, the at least one controller is configured to operatively couple to a power source and/rot with a communication platform.

In another aspect, one or more non-transitory computer readable media comprising program instruction physically inscribed thereon, the program instructions, when read by one or more processors, are configured to execute, or direct execution of, one or more operations of any of the above methods to fabricate the device.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions are inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions are inscribed on at least one medium (e.g., on a medium or on media).

In another aspect, an apparatus comprises at least one controller that is configured (e.g., programmed) to direct a mechanism used in a methodology disclosed herein to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or be operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions, when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a mechanism, outside of the mechanism, or in a location remote from the mechanism disclosed herein (e.g., in the cloud).

In another aspect, a system comprises an apparatus and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein. In some embodiments, at least two operations (e.g., instructions) of the apparatus are directed by the same controller. In some embodiments, at least two operations (e.g., instructions) of the apparatus are directed by different controllers. In some embodiments, at least two operations (e.g., instructions) are carried out by the same processor and/or by the same sub-computer software product. In some embodiments, at least two of operations (e.g., instructions) are carried out by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method comprises executing one or more operations associated with at least one configuration of the mechanism(s) (e.g., device(s)) disclosed herein.

In another aspect, an apparatus comprises at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprises at least one connector configured to connect to a power source. In some embodiments, the at least one controller being configured to operatively couple with a power source at least in part by (I) having a power socket and/or (II) being configured for wireless power transfer using inductive charging. In some embodiments, the at least one controller comprises a non-volatile memory, e.g., a solid-state device (SSD) such as a FLASH memory. In some embodiments, the at least one controller is included in, or comprises, a hierarchical control system. In some embodiments, the hierarchical control system comprises at least three hierarchical control levels. In some embodiments, the at least one controller is included in a control system disclosed herein. In some embodiments, the at least one controller is configured to control at least one other component of a mechanism (e.g., system, device, or apparatus) disclosed herein. In some embodiments, the device disclosed herein is a component of a system, and wherein the at least one controller is configured to (i) operatively couple to another component of the system and (ii) direct operation of the other component. In some embodiments, the at least one controller is configured to direct operation of the other component at least in part for participation of the other component in a method disclosed herein.

In another aspect, non-transitory computer readable program instructions for a method disclosed herein, the non-transitory computer readable program instructions, when read by one or more processors operatively coupled with the device, cause the one or more processors to direct executing one or more operations associated with at least one configuration of the device(s) disclosed herein.

In some embodiments, the program instructions are of a computer product.

The various embodiments in any of the above aspects are combinable (e.g., within an aspect), as appropriate. Individual features (e.g., embodiments) disclosed herein are combinable in any manner requested and/or desired, as applicable.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

It should be appreciated that any patent, publication, or other disclosure material, in whole or in part, which is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

### BRIEF DESCRIPTION OF DRAWINGS

The present disclosure, in accordance with one or more various implementations, is described in detail with reference to the following drawings. The drawings are provided for purposes of illustration only and merely depict typical or example implementations. These drawings are provided to facilitate an understanding of the concepts disclosed herein and should not be considered limiting the breadth, scope, or applicability of these concepts. It should be noted that for clarity and ease of illustration, these drawings are not necessarily made to scale.

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” herein), of which:

FIG. 1 schematically depicts a graph and various cell configurations;

FIG. 2 schematically depicts cells in batteries at various conditions;

FIG. 3 schematically depicts various batteries;

FIG. 4 schematically depicts cell sets in batteries;

FIG. 5 schematically depicts cells in a battery as a perspective view. The battery is formed by using an aluminum oxide paste on a cell, in accordance with some implementations of the subject matter of the disclosure;

FIG. 6 schematically depicts insulators;

FIG. 7 shows a cross sectional image of a dynamic insulator that was deposited as an aluminum oxide paste on a cell, in accordance with some implementations of the subject matter of the disclosure;

FIG. 8 shows a cross sectional image of a dynamic insulator that was deposited as an aluminum oxide paste on a cell, in accordance with some implementations of the subject matter of the disclosure;

FIG. 9 shows a cross sectional image of a dynamic insulator comprising polymer particles deposited on a cell, in accordance with some implementations of the subject matter of the disclosure; and

FIG. 10 show graphs depicting current, voltage, and temperature over time, as experienced by different batteries;

FIG. 11 shows a control system;

FIG. 12 shows a processing system; and

FIG. 13 shows cross sections of batteries.

The figures and components therein may not be drawn to scale. Various components of the figures described herein may not be drawn to scale.

### DETAILED DESCRIPTION

While various embodiments of the inventions have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Terms such as “a,” “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”—including in the specification and claims—is meant to include the options (i) X, (ii) Y, and (iii) X and Y, as applicable. The phrase “including X, and/or Y” is meant to have the same meaning as the phrase “comprising X or Y.”

When ranges are specified for an attribute, it is meant herein that the attribute may include the value specified at the end of the range. For example, when the attribute is of a value of at least about X, the attribute can be X, or any value greater than X. For example, when the attribute is of a value of at most about Y, the attribute can be Y, or any value smaller than Y. For example, when the attribute is of a value from V to Z, the attribute can be V, the attribute can be Z, or the attribute can be any value between V and Z.

The term “operatively coupled,” “operatively configured,” or “operatively connected” refers to a first mechanism that is coupled (or connected) to a second mechanism to allow the intended operation of the second and/or first mechanism. The coupling may comprise physical or non-physical coupling. The non-physical coupling may comprise signal-induced coupling (e.g., wireless coupling).

The phrase “is/are structured” or “is/are configured,” when modifying an article, refers to a structure of the article that can bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter equivalent of a bounding sphere, a radius, a spherical equivalent radius, or a radius of a bounding circle, or a radius of a bounding sphere.

A central tendency as understood herein comprises mean, median, or mode. The mean may comprise a geometric mean.

Performing a reversible first operation is understood herein to mean performing the first operation and being capable of performing the opposite operation to that first operation (e.g., which is a second operation). For example, when a controller directs reversibly opening a shutter, that shutter can also close, and the controller can optionally direct a closure of that shutter. For example, when an attractor reversibly binds to a charge carrier, that attractor can also release that charge carrier after its binding.

As noted herein, implementations of the present disclosure relate to (e.g., secondary) batteries, the structures that make up the (e.g., secondary) batteries, and the methods and processes for manufacturing the structures and batteries. As used herein, the term “anode” used in the context of a secondary battery may refer to the negative electrode in a (e.g., secondary) battery. “Anode material” or “anodically active” as used herein, may refer to a material or materials suitable for use as the negative electrode of a (e.g., secondary) battery. The term “cathode” as used herein in the context of a (e.g., secondary) battery may refer to the positive electrode in a secondary battery. “Cathode material” or “cathodically active” as used herein, may refer to a material or materials suitable for use as the positive electrode of a (e.g., secondary) battery.

In some implementations described herein, the term “electrode” may be used to refer to either the anode or the cathode, and the term “counter-electrode” may refer to the other or opposite electrode. For the sake of explanation (e.g., for didactive purposes), implementations may be described in terms of “electrode” and “counter-electrode.” It should be appreciated that in these implementations, the term electrode may be replaced by the term anode while the term counter-electrode may be replaced by the term cathode. Alternatively, in these implementations, the term electrode may be replaced by the term cathode while the term counter-electrode may be replaced by the term anode.

Curtailing may comprise deterring, slowing, hindering, slowing, limiting, halting, shutting off, ceasing, or stopping. Curtail may comprise deter, slow, hinder, slow, limit, halt, shut off, cease, or stop.

In some embodiments, the battery is configured to curtail (e.g., reduce, or prevent) the occurrence of battery heat-up and/or runaway reaction, e.g., due to residual current. At times, when a residual current in the cell exceeds an activation energy barrier, a thermal runaway (e.g., exothermic) reaction starts resulting in (additional) heating of the battery, e.g., that may be uncontrollable. Such uncontrollable heating and/or reaction may cause adverse effect(s) such as disclosed herein. The adverse effects may comprise substantial harm, e.g., damage. The adverse effect may be irreversible, uncontrollable, cause the cell to operate outside of its prescribed specifications, and/or cause the battery to operate outside of its prescribed specification. The specification may be prescribed by the battery manufacturer and/or the client. In an example, the substantial damage is to the battery, to an inanimate object in an ambient environment external to the battery, to personnel in the ambient environment external to the battery, or any combination thereof. The substantial damage may be caused at least in part by the cell catching fire and/or exploding. It may therefore be beneficial to curtail (e.g., prevent) such substantial temperature rise and/or runaway reaction within the battery. The battery may be a primary or a secondary battery. The battery may or may not be rechargeable. The battery may or may not be a single use battery. The battery may comprise a primary battery cell, or a secondary battery cell. The battery may be a primary battery or a secondary battery. The battery may assume a configuration of a cylinder or a prism. The battery may comprise one or more battery cells. The battery cell may be folded, assume a (e.g., substantially) planar configuration, or be folder, e.g., in a fold comprising a spiral, sinusoidal, zigzag, or top-hat, fold. A set of battery cells may be disposed one on top of each other.

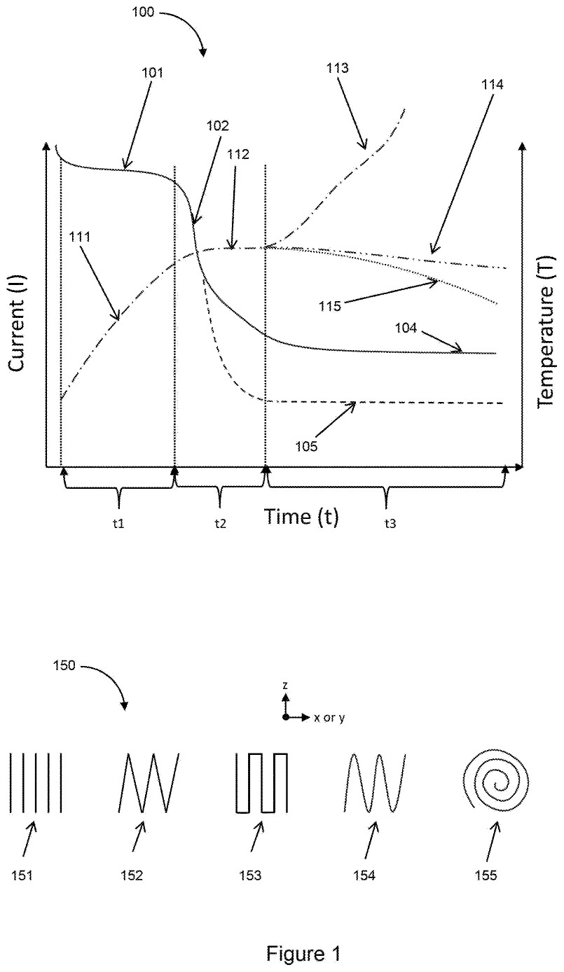

FIG. 1 shows in example 100 a schematic graph depicting battery current (I) over time (t), and temperature (T) of the battery over the time (t), in which are subject to an External Short Circuit (ESC) test, e.g., not during normal operation of the batteries. Section 111 during time window t1 depicts an initial heating of the battery, the heating hardly affects the current 101, above a threshold temperature, the current greatly diminishes, which is depicted during time window t2. The fast-diminishing current may be attributed to effective elimination of the load current, e.g., due to shutoff of the separator. Section 102 of the current graph, depicts the steep reduction of the current in the battery during temperature approaching threshold 112, occurring during time window t2. While the main current may be greatly diminished, a residual current 104 can remain in the battery. The residual current can contribute to continuous increase of the battery temperature above threshold temperature 112. Such an increase in temperature may initiate a runaway reaction contributing to uncontrollable temperature increase as depicted in 113 occurring in time window t3. When the residual current also diminishes, e.g., as is depicted in 105, the temperature of the battery may remain (e.g., substantial) constant, e.g., as is depicted in 114, or may reduce, as is depicted in 115. Reduction of the temperature may occur when the current (e.g., 105) is sufficiently curtailed, e.g., diminishes effectively to zero, or to a measurably zero current.

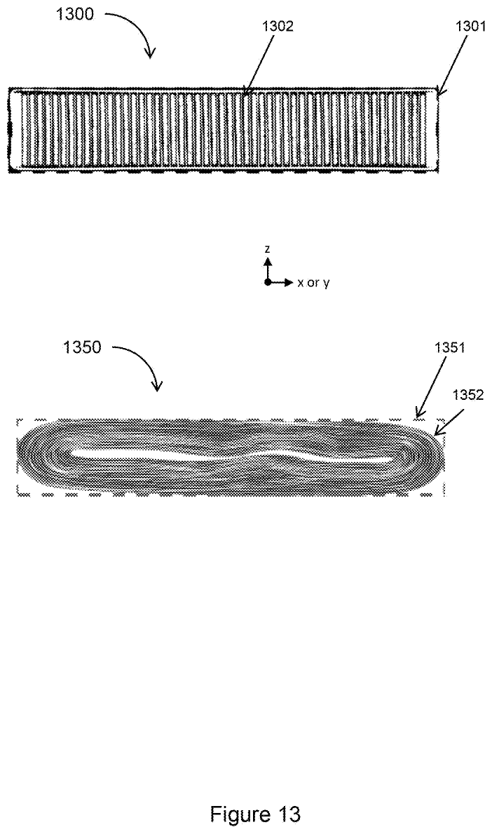

FIG. 1 shows in example 100 a schematic vertical cross section in a battery, showing arrangement and/or folding of battery cells with respect to a Cartesian coordinate system. In example 151, battery cells are arranged parallel to each other. Examples 152-155 show various folding of a sheet comprising one or more battery cells, with 152 showing a zigzag fold, 153 showing a top hat fold, 154 showing a sinusoidal fold, and 155 showing a spiral (e.g., rolling) fold. The battery may comprise a battery cell folded in a wound (e.g., jelly roll) configuration having an oblong or cylindrical configuration, e.g., as shown in FIG. 13, 1350.

In some embodiments, a battery comprises at least one cell. A cell may comprise two opposing electrodes (an anode and a cathode) separated from each other by a separation space. The separation space may comprise an electrolyte or a separator. The separation space may comprise more than one separator. In an example, the separation space comprises the electrolyte and the separator, e.g., comping a polymer or a resin. Under normal conditions, the separator can be configured (a) to hinder (e.g., prevent) contact between the two opposing electrodes of the cell, and (b) to allow charge carriers to pass through the separator when propagating (e.g., progressing, or traveling) from one electrode to its opposing electrode. The normal conditions may comprise normal operation, (e.g., physical storage such as in a warehouse) storage, maintenance, or shipping conditions, e.g., ambient conditions. Under the normal conditions, the charge carriers may pass from one opposing electrode to another at least in part by using the electrolyte. The electrolyte may comprise of one or more distinct chemical types. The charge carrier may comprise a positively charged ion (cation), e.g., a metal cation of an alkali metal or an alkali earth metal. In an example, the charged ion is lithium. Lithium based batteries (e.g., Lithium-based secondary batteries) are a type of energy manipulation (e.g., energy storage) device having one or more cells. In some embodiments, a cell comprises carrier ions that propagate between the opposing electrodes during use, at least in part by using electrolyte, e.g., propagate between a cathode structure and an anode structure at least in part by using the electrolyte. In an example, lithium-based secondary batteries are a type of energy manipulation (e.g., energy storage) device having cells in which carrier ions, such as lithium, sodium, potassium, calcium or magnesium ions, travel between a cathode structure and an anode structure through an electrolyte within each cell. The carrier ions may comprise lithium, sodium, potassium, calcium, or magnesium ions. The opposing electrodes (e.g., the anode structure and cathode structure) are separated by the separator structure (also referred to herein as the “separator”) disposed in the separation space. The separation between the opposing electrodes may occur during the normal conditions. The normal conditions may comprise during use, e.g., at a time comprising (a) during assembly of the battery, or (b) during battery operation. Current collectors (e.g., wires) can pull electric current from the respective current carrying electrode and enable transfer of the current from the cell to the external environment, e.g., to the ambient environment external to the battery housing. An electrode may be operatively coupled with one or more current collector(s). In an example, an electrode is operatively coupled (e.g., connected) to at least one current collector such as wire. In an example, current from the respective active electrochemical electrodes and enable transfer of the current to the environment outside the battery. In an example, each of the anode and cathode current collectors pull electric current from the respective active electrochemical electrodes and enable transfer of the current to the environment outside the battery, e.g., and outside of the battery housing. In an example, an anode current collector is configured to pull electric current from an anode, e.g., to transfer the current to the environment outside the cell and/or the battery such as outside of the battery housing. In an example, a cathode current collector is configured to pull electric current from a cathode, e.g., to transfer the current to the environment outside the cell and/or the battery such as outside of the battery housing. The battery may comprise one or more cells. The battery may comprise a housing. The current collector may carry the current outside of the cell and into the battery housing, outside of the battery housing, or a combination thereof. The current collectors of the anodes in a set of cells may be coupled (e.g., in parallel) to a main anode current collector. The current collectors of the cathode in a set of cells may be coupled (e.g., in parallel) to a main cathode current collector. The main cathode current collector may be disposed on the same face of the set of cells as the main anode current collector. The main cathode current collector may be disposed on a different face (e.g., at an opposing face) of the set of cells as the main anode current collector. The external battery contacts on a face parallel to, or normal to, to the long axis of the electrode of the cell.

In some embodiments, a battery cell comprises a pair of opposing electrodes and a separation space disposed between the opposing electrodes of the pair. In some embodiments, the electrode assumes the shape of a sheet. The sheet may be planar. The sheet may be substantially two dimensional. The thickness of the sheet may be substantially smaller than the length of the sheet, and substantially smaller than the width of the sheet. The separation space may comprise a separator, e.g., having a shape of a sheet. The electrode and/or separator, may be elongated. A subject face may be of a cell or of a component of the cell, the subject face having the largest surface area of the component's faces, e.g., face types. The component of the cell may comprise a reference electrode, its counter electrode, or the separator. The subject face may be of the battery cell. The ratio of a subject face of the component, the subject face having the largest surface area of the faces of the component, may be at least about 1:2, 1:5, 1:10, 1:50, 1:100, or 1:500 width per length. The face may be of the electrode of the cell (e.g., anode), or of the separator of the cell. The cell may be configured for deposition in a prismatic (e.g., cuboid) housing. The subject face may assume a shape configured to fit in a cross section of a face of the prism different than the face having the largest cross-sectional area. The subject face may assume a shape configured to fit in a cross section of the face of the prism having the smallest cross-sectional area. The face of the prism having the smallest cross-sectional area, can fit at most an integer number of the subject face, the integer number being at most about 5, 4, 3, 2, or 1. In an example, the face of the prism having the smallest cross-sectional area, can fit at most one subject face. The subject face may assume a shape configured to fit in a cross section of a face of the prism having the medium sized cross-sectional area. The face of the prism having the medium cross-sectional area, can fit at most an integer number of the subject face, the integer number being at most about 5, 4, 3, 2, or 1. In an example, the face of the prism having the medium cross-sectional area, can fit at most one subject face. The face of the prism having the largest cross-sectional area, can fit at most an integer number of the subject face, the integer number being at most about 5, 4, 3, 2, or 1. In an example, the face of the prism having the largest cross-sectional area, can fit at most one subject face. The largest cross-sectional area of the subject face may be elongated, e.g., rectangular.

In some embodiments, the cell comprises a separator. The separator may be configured (a) to curtail (e.g., hinder or prevent) the cathode from contacting the anode, and (b) to allow ions to pass through the separator from one electrode to its opposing electrode, the ions passing at least in part by using electrolyte disposed at least between the opposing electrodes in the separation space. In an example, the separator is disposed between the opposing electrodes in a battery cell (also referred to therein as the “cell”). The separator may extend outside the surface of the opposing electrodes, which surfaces face each other. The electrolyte may be disposed (e.g., situated, or located) withing the battery housing. The electrolyte may be disposed in the cell. The electrolyte may be disposed within the immediate location of the cell. The electrolyte may comprise a polymer, a mixture of polymers. The polymer may be a copolymer. The electrolyte may contact the cell (e.g., also) outside of the separation space. The electrolyte may be disposed in a volume contacting the cell. In an example, the electrolyte is disposed in the battery housing, e.g., in a volume isolated (e.g., separated) from the ambient environment external to the battery housing. The isolated surrounding may comprise one or more cells.

In some embodiments, the separator is configured to (i) be electrically insulating and (ii) allow for ionic conduction of the charge carriers. In an example, the ionic conduction may initiate once the electrolyte fills the pore space. The separator may be configured to allow the charge carriers, such as lithium ions, to pass through from one face of the separator to its opposing face. The ionic conduction may be facilitated (e.g., done) at least in part by the charge carriers. The ionic conduction may be facilitated (e.g., done) at least in part by the electrolyte. The ionic conduction may take place during conditions of the cell comprising during use or during its storage. The ionic conduction may effectuate (e.g., be done) during operation and/or during an electrode buffering process of the cell, e.g., during pre-charging of the anode with the charge carriers. The charge carriers may be of one or more chemical types. In an example, the ionic conduction is done during operation and/or during a pre-lithiation (or buffer) process of the cell, e.g., pre-lithiation of the anode.

In some embodiments, a battery cell comprises an electrode (e.g., reference electrode), a counter electrode, and a separation space. The separation space may comprise a separator, e.g., having a material comprising conduits or pores, e.g., micro conduits, or micropores. The pores and/or conduits may be configured to facilitate ions to propagate through the pores. The conduits may be channels. Pores of the separator may be coupled with form the conduit. The battery cell may comprise, or may be coupled with, an insulator such as a dynamic insulator. The battery cell may comprise, or may be coupled with, a dividing space. At least one component may be electrically insulating, e.g., the separator body, the insulator, or at least one component of the dividing space. The dividing space and the separating space may or may not have the same material content.

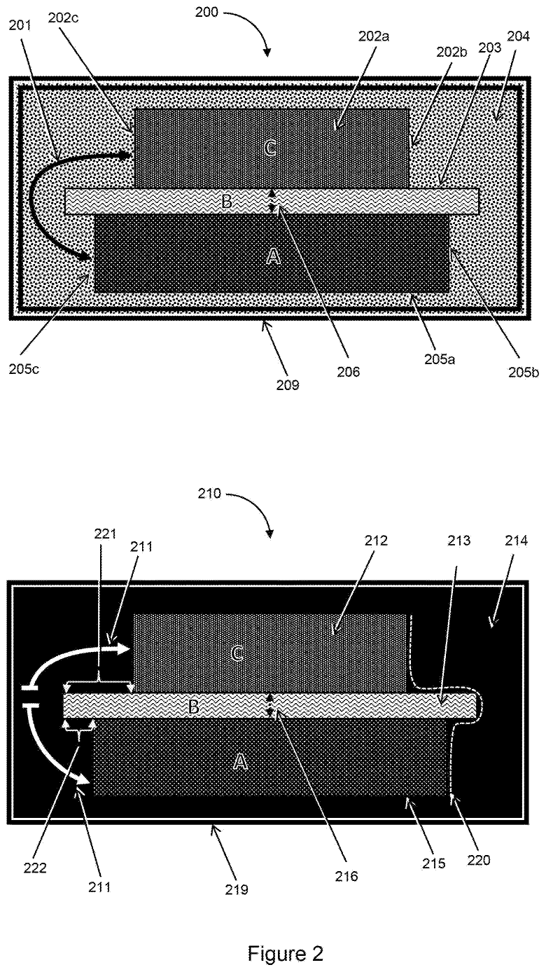

FIG. 2 shows in example 200 a schematic representation of a battery cell, the battery cell comprising an electrode 202a-C (e.g., a cathode), and an opposing electrode 205a-A (e.g., an anode). A separator is disposed in separator space 203-B. The battery cell is disposed in a battery having housing 209. The battery can optionally have an insulator 204 that may or may not be the dynamic insulator. Under normal conditions during use of the battery, the main current is a load current 206 passing from one electrode to its opposing electrode, and through separation space 203. There may be a residual current 201 passing outside of separation space B, and through volume 204, e.g., through the dynamic insulator. When temperature rises, the separator in separation space 203 may shut down, greatly diminishing (e.g., eliminating) the flow of the load current 206. A triggering event of current shut down through a volume may comprise temperature above a threshold, flow of charge carriers above a threshold, concentration of the charge carriers above a threshold. When the insulator in space 204 is unsusceptible to a triggering event, the residual current will continue to flow between the opposing electrodes, even though components of the separation space (e.g., 203) will be susceptible to the triggering event, e.g., and consequently the load current will (e.g., effectively) shut down. When the insulator in space 204 has a susceptibility to a triggering event that is different from (e.g., lower than) that of components of the separation space (e.g., to the separator), the residual current may continue to flow between the opposing electrodes, even though the load current is (e.g., effectively) shut down. In these cases, a shut down on the separator in separation space 203 will not affect the flow of residual current 201. If volume 204 comprises an insulator, the insulator contacts at least at opposing sides 202b and 202c of electrode 202a and at opposing sides 205b and 205c of counter-electrode 205a.

FIG. 2 shows in example 210 a schematic representation of a battery cell, the battery cell comprising an electrode 212-C (e.g., a cathode), and an opposing electrode 215-A (e.g., an anode). A separator is disposed in separator space 213-B. The battery cell is disposed in a battery having housing 219. The separation space extends 221 beyond electrode 212, and extends 222 beyond counter electrode 215, the extension being along a long axis of each of the electrode, the long axis depicted in FIG. 2. The battery has a dynamic insulator 204 that was triggered due to a triggering event experienced in the dynamic insulator. The triggering event may comprise temperature above a threshold, flow of charge carriers above a threshold, concentration of the charge carriers above a threshold. Under the event triggering conditions, the load current 216 may or may not be passing through separation space 203. In an example, during the triggering conditions the load current is (e.g., substantially, and/or effectively) shut down. The triggering event may cause the dynamic insulator to curtail (e.g., effectively stop) the residual current. In the example shown in 210, residual current 211 does not pass through space 214 and outside of separation space B, volume 214 comprises (e.g., is filled by) the dynamic insulator. A change between the interiors 204 and 214 can depict a change in the dynamic insulator due to the triggering event. The triggering event(s) of the materials in the separation space (B) (e.g., of the separator) may or may not be (e.g., substantially) the same as the triggering event(s) of the dynamic insulator (e.g., of the insulating material). The dynamic separator may be configured to shut down the residual current before, after, or during the time at which the load current is shut down, e.g., due to a change in the separator and/or in the electrolyte in the separation space.

In some embodiments, one or more cells are disposed within a housing to form the battery. The housing may insulate the battery from one or more reactive agents in the ambient environment external to the battery. The reactive agent(s) may comprise oxygen, water, alcohol, thiol, sulfuric acid, phosphoric acid, carboxylic acid, or hydrogen sulfide. The reactive agent(s) may be oxygen based, sulfur based, and/or phosphorous based. The reactive agent(s) may comprise water or oxygen. In an example, the reactive agent(s) comprise water in a liquid and/or vapor form. The water may be in a droplet form. The housing may be configured to insulate the cell(s) from the reactive agent(s) present in the ambient environment external to the battery, e.g., to curtail (e.g., hinder, or prevent) reactive agent(s) from reaching the cell such as including reaching the electrode(s).

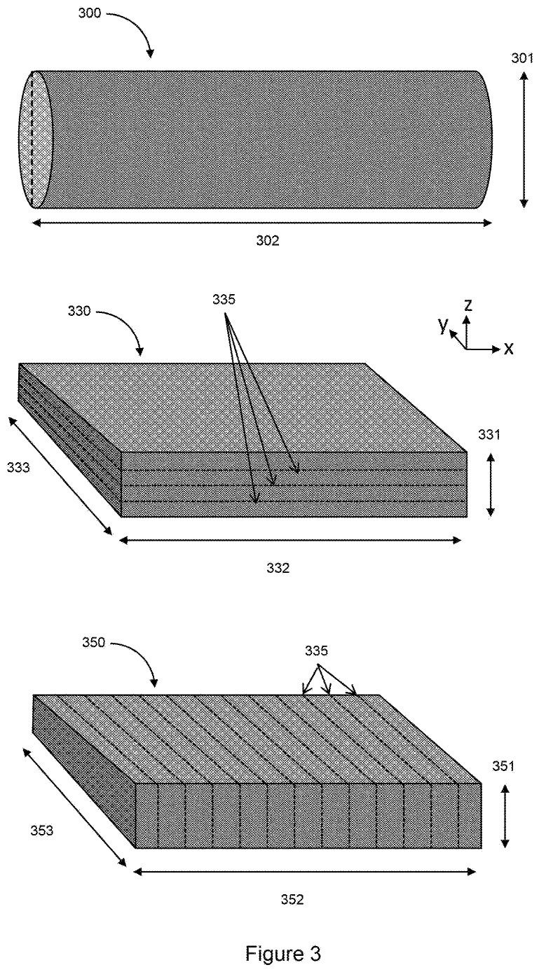

FIG. 3 shows schematic perspective view examples of batteries and battery cell architecture therein relative to a Cartesian coordinate system. Example 300 shows a cylindrical battery housing having a length 302 and height 301, which is a diameter. The battery may comprise cell(s) that form a rolled sheet. In example 300, each of the bottom and top faces of the cylinder has a smaller surface area as compared to the side surface of the cylinder—to the curved surface of the cylinder. Example 330 shows a prismatic battery housing that is a rectangular prism, or a cuboid. The battery has length 332, height 331, and width 333. Battery cells 335 are stacked in the battery along height 331, and along the Z direction. In example 330, face XY has a larger surface area than face XZ, and face XY has a larger surface area than face YZ. Example 350 shows a prismatic battery housing that is a rectangular prism, or a cuboid. The battery has length 352, height 351, and width 353. Battery cells 355 are stacked in the battery along length 352, and along the X direction. In example 350, face XY has a larger surface area than face XZ, and face XY has a larger surface area than face YZ.

In some embodiments, the cell is arranged (e.g., substantially) perpendicular to the face of a prismatic (e.g., cuboid) battery having the largest surface area. At times, the largest surface area face of the anode, the separation space, the separator, the cathode, and/or the dividing space, is disposed (e.g., substantially) normal to the face of the battery having the largest surface area. FIG. 3, 350 shows an example of battery cells such as cells 335, disposed normal to the XY face of the battery, which XY face has the largest surface area among the battery's faces. The surface area of the cell, in example 350, is at most the surface area of YZ face of the battery, or smaller. Cells arranged normal to the largest surface area face of the battery in which they are disposed (e.g., FIG. 3, 350), have a larger combined cell side (e.g., edge) surface area, as compared to (a) cells arranged parallel to the largest surface area face of the battery in which they are disposed (e.g., FIG. 3, 330) and/or to (b) cylindrical battery such as a wound cell (e.g., jelly roll) battery (e.g., FIG. 3, 300). In some embodiments, the greater the combined side (e.g., edge) surface area of the cells, the greater the residual current role is in the total current of the battery. When the cell comprises at least one uneven side, e.g., as is depicted in FIG. 2, 220, the uneven (e.g., misaligned) side creates a wavy side of a set of cells. The wavy side may or may not contribute to the amount of residual current passing between an anode and a cathode of a cell, e.g., through the insulator.

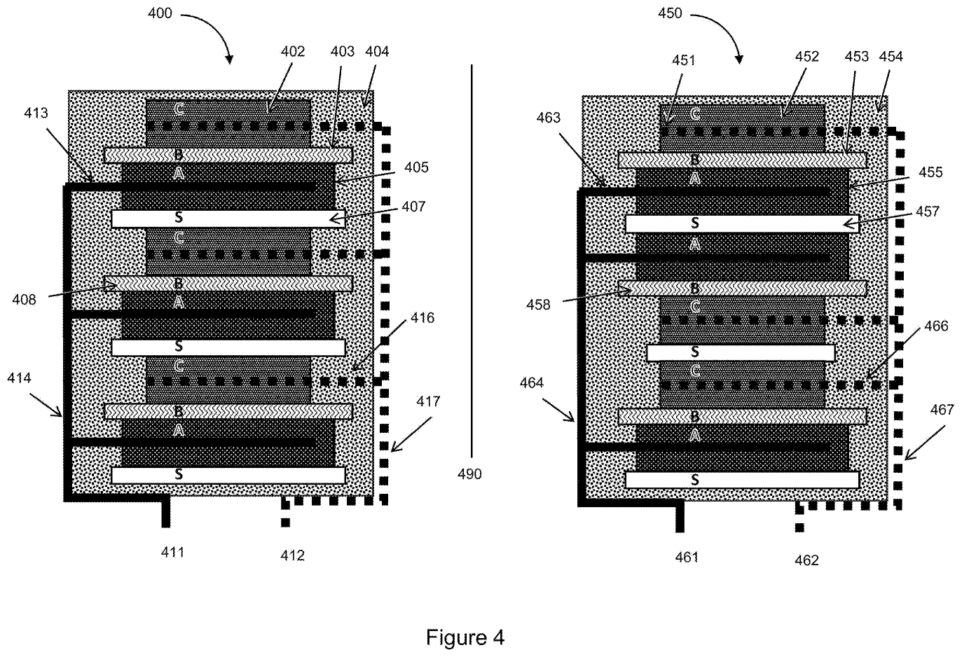

In some embodiments, the battery comprises battery cells. The battery cells may be stacked along an axis. A dividing space may be disposed between every two immediately adjacent cells such that a first cell contacts the first face of the dividing space, and a second cell contacts a second face of the dividing space opposing its first space. The dividing space may comprise an insulator, e.g., any insulator disclosed herein. The insulator may or may not comprise the dynamic insulator. The dividing space may be configured to electrically separate one cell from another. The battery stacks may follow a pattern, the pattern may comprise a sequence. The sequence may comprise an arrangement of components of the battery cell with respect to each other. The sequence may comprise an anode, a separation space, a cathode, and a dividing space. The sequence may follow a CBAS pattern, or a CBASABCS pattern, with C designating a cathode, B designating a separation space, A designating an anode, and S designating the dividing space, e.g., see FIG. 4. The battery cells may be stacked in one or more groups. The separation space may comprise two opposing faces. A face of the separation space contacting the anode, and an opposing face contacting the cathode. The cell may comprise components comprising an anode, a cathode, a separation space, and an optional dividing space. The components of the cell may be disposed along an axis. The components of the cell may be (e.g., substantially) symmetrically arranged along the axis, e.g., in mirror symmetry, the mirror plane running along the axis, and/or in a rotational symmetry, the rotational axis running along the cell stacking axis (e.g., parallel to axis 490 in FIG. 4). At least two components of the cell may extend in a direction (e.g., substantially) perpendicular to the cell stacking axis at a (e.g., substantially) same distance. At least two components of the cell may extend in a direction (e.g., substantially) perpendicular to the cell stacking axis at a different distance. The different distance extension of the components forms a corrugated (e.g., misaligned) face of the cell, and of the set of cells, e.g., as depicted in FIG. 2, 220. See also sides (e.g., edges) of cell sets in FIG. 4, 400, and 450. In an example, the cathode extends less than the anode, the extension being in a direction perpendicular to the cell stacking axis. In an example, the separation space extends more than the anode and/or more than the cathode, the extension being in a direction perpendicular to the cell stacking axis.

FIG. 4 shows a schematic cross-sectional example 400 of a battery comprising cathode 402, anode 405, separation space 406, and dividing space 407. The battery cells are disposed in volume 404 of the battery that can include an insulator such as a dynamic insulator. The battery cells are stacked along an axis 490, in a repeating CBAS arrangement. Each anode A in the battery is operatively coupled (e.g., connected) with a current collector such as 413, the anode current collectors being coupled in parallel to a main anode current collector 414, ending with cathode contact 411. Each cathode C in the battery is operatively coupled (e.g., connected) with a current collector such as 416, the anode current collectors being coupled in parallel to a main cathode current collector 417, ending with anode contact 412.

FIG. 4 shows a schematic cross-sectional example 450 of a battery comprising cathode 452, anode 455, separation space 456, and dividing space 457. The battery cells are disposed in volume 454 of the battery that can include an insulator such as a dynamic insulator. The battery cells are stacked along an axis 490, in a repeating CBASABCS arrangement. Each anode A in the battery is operatively coupled (e.g., connected) with a current collector such as 463, the anode current collectors being coupled in parallel to a main anode current collector 464, ending with cathode contact 461. Each cathode C in the battery is operatively coupled (e.g., connected) with a current collector such as 466, the anode current collectors being coupled in parallel to a main cathode current collector 467, ending with anode contact 462. In FIG. 4, the main cathode current collector is disposed on a different face of the set of cells as the main anode current collector, which is the opposing face.

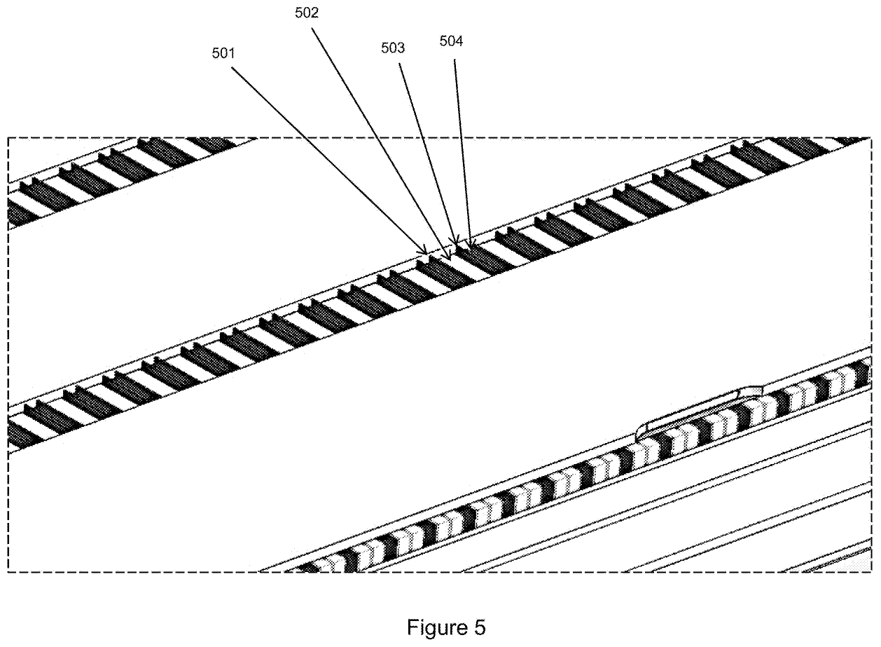

FIG. 5 shows an example of a battery portion having stacked cells comprising dividing space 501 (S), anode 502 (A), separator space 503 (e.g., comprising a separator) (B), and cathode 504 (C), the cell repeating in a SABC sequence. In the example shown in FIG. 5, dividing space 501 is (e.g., substantially) identical to separator space 503, e.g., in terms of its material content and/or general physical dimensions. The wavy (e.g., misaligned) formation of the sides (e.g., edges) of the cells in the set of cells shows at the exposed portion of the stacked battery cells in the sequence of cells, e.g., the cell comprising components 502-504. The content of the separator space can be (e.g., substantially the same) as the dividing space.

In some embodiments, the battery comprises an insulator. The insulator may comprise a ceramic material. The ceramic may comprise alumina (Al₂O₃), zirconia (ZnO₂), magnesium oxide (MgO), boron nitride (BN), mullite, boehmite, or silicon carbide (SiC, e.g., in pure form). The insulator may comprise an allotrope of elemental carbon that is non-conductive. The non-conductive allotrope of elemental carbon may comprise amorphous carbon, carbon foam (e.g., nanofoam), or Z-ACA allotrope. In an example, some (e.g., secondary) batteries rely on a paste of aluminum oxide (alumina) to create a porous layer on both XY faces of a cell. The ceramic may be utilized with or without an additive, e.g., the additive comprises a polymer or a resin. The ceramic may be deposited during the battery generation process, e.g., as a slurry that includes a solvent such as a hydrophobic solvent, e.g., Naphtha. The hydrophobic solvent may comprise aromatic or aliphatic compound. The hydrophobic solvent may be branched. The slurry may comprise a solvent, a binder (e.g., polymer), and a ceramic (e.g., alumina). The binder can comprise an anhydride, or an alkene. The polymer may be a copolymer. The solvent can comprise an aromatic hydrocarbon. The viscosity of the slurry utilized for deposition of the insulator can be at least about 1500 centipoise (cP), 1700 cP, 1750 cP, 2000 cP, 2570 cP, or 3000 cP, e.g., at ambient temperature or at 37 °C. The viscosity of the slurry utilized for deposition of the insulator can be at most about 1700 cP, 1750 cP, 2000 cP, 2570 cP, 3000 cP, or 4000 cP. The viscosity of the slurry utilized for deposition of the insulator can be at of any viscosity values between the aforementioned viscosity values, e.g., from about to about, or from about to about. The viscosity can be measured at ambient temperature, e.g., at 20 °C, 25 °C, 30 °C or 35 °C. During manufacturing (e.g., during deposition), the dynamic insulator (e.g., slurry thereof) may assume the same viscosity properties as the non-dynamic (e.g., ceramic) insulator (e.g., slurry thereof). In an example, when there is an external short circuit (ESC) that causes the loading current to effectively cease, (e.g., ionic) current can continue to pass from the anode to the cathode through the insulator (e.g., through the aluminum oxide layer), even after the separator has reached its shutdown temperature. The insulator can exclude a dynamic component susceptible to the triggering event such as the shutdown temperature of the separator. A non-dynamic insulator can exclude a dynamic component susceptible to the triggering event in an amount in which the dynamic component will (e.g., substantially and/or measurably) curtail the flow of residual current and/or ions though the insulator volume. In an example, the non-dynamic insulator excludes a dynamic component susceptible to the triggering event in an amount in which the dynamic component will (e.g., substantially and/or measurably) stop the flow of residual current and/or flow of ions though the insulator volume. When there is an external short circuit (ESC) event, ionic current can continue to pass from one electrode to its opposing electrode (e.g., from the anode to the cathode) through the electrolyte of the insulator (e.g., comprising an aluminum oxide layer) electrolyte, e.g., after the separator has reached its shutdown temperature. In an example, the insulator (this porous layer) must be electrically insulating to avoid shorts and (e.g., but) also allow for ionic conduction once the electrolyte fills the pore space—to allow lithium ions to pass through during the pre-lithiation (or buffer) process. In an example, a dynamic insulator susceptible to the triggering even(s) can also help prevent shorting between the cathode and anode.

In some embodiments, the battery and/or cell comprises a polymer. The polymer may comprise a copolymer, or a polymer mixture. The polymer may be included in the insulator, in the electrode, in the separator space, in the dividing space, or any combination thereof. The battery and/or the battery cell, may comprise at least one type of the polymer. At least two components of the cell and/or battery, may comprise the same polymer type. At least two components of the cell and/or battery may comprise different polymer types. In an example, the polymer is hydrophobic. In an example, the polymer is non-aqueous and/or non-polar.

In some embodiments, the battery and/or cell comprises a resin. The resin may comprise a resin mixture. The resin may be included in the insulator, in the electrode, in the separator space, in the dividing space, or any combination thereof. The battery and/or the battery cell, may comprise at least one type of the resin. At least two components of the cell and/or battery, may comprise the same resin type. At least two components of the cell and/or battery may comprise different resin types. In an example, the resin is hydrophobic. In an example, the resin is non-aqueous and/or non-polar.

In some embodiments, the battery and/or cell comprises an electrolyte. The electrolyte may comprise an electrolyte mixture. The electrolyte may be included in the insulator, in the electrode, in the separator space, in the dividing space, or any combination thereof. The battery and/or the battery cell, may comprise at least one type of the electrolyte. At least two components of the cell and/or battery, may comprise the same electrolyte type. At least two components of the cell and/or battery may comprise different electrolyte types. The electrolyte may be configured to be compatible with utilization of the battery at least under the normal conditions. In an example, the electrolyte is hydrophobic. In an example, the electrolyte is non aqueous and/or non-polar.

In some embodiments, the insulator is a dynamic insulator. The dynamic insulator may comprise a polymer, a resin, or an electrolyte. The dynamic insulator may or may not (e.g., also) comprise the ceramic. In an example, the dynamic insulator comprises a porous layer. In an example, the cell and/or battery includes the dynamic insulator. The dynamic insulator (porous layer) may help in curtailing (e.g., hindering or preventing) current shorting event(s) occurring between the opposing electrodes (cathode and anode) of the cell.

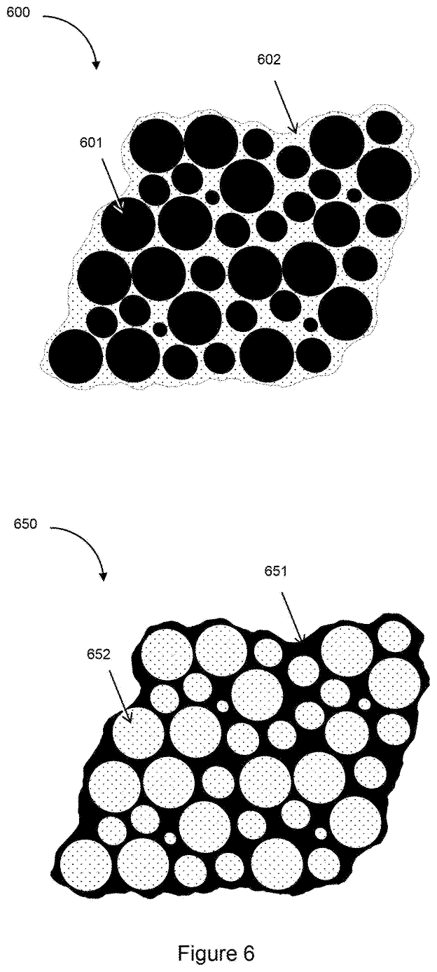

In some embodiments, the battery comprises (e.g. and rely on) the dynamic insulator (also referred to herein as an “insulating layer”) in which one or more insulating material types are disposed in a volume. The dynamic insulator may contact one or more faces of the cell(s). An example of the insulating layer is a porous polymer layer, e.g., as depicted in example 500 or 550. In the volume of the dynamic insulator, (a) a physical disposition of the insulating and/or (b) a chemical type of the insulating material, may be configured to allow the electrolyte to occupy (e.g., and flow in) part of the volume at certain condition(s) in which the battery is found it, e.g., in the normal conditions comprising during use or during its storage, of the battery. The dynamic insulator may be configured to allow charge carriers (e.g., metal ions), and optionally also the electrolyte, to pass through the volume of the dynamic insulator at the normal condition(s), e.g., pass through the volume in which the insulating material is disposed. In an example, the dynamic insulator comprises a semisolid material (e.g., gel), or a solid (e.g., a hardened material), occupying the volume. In an example, the dynamic insulator comprises a particulate material occupying the volume, e.g., FIG. 6, 600. The insulating material may be in the form of a scaffold, or a matrix, in the volume, e.g., FIG. 6, 650. The insulator may comprise a portion devoid of the insulating material, e.g., also referred to herein as the “void fraction.” The void fraction may be at least about 5%, 10%, 20%, or 30% of the volume of the insulator. The void fraction may be at most about 35%, 30%, 20%, 10%, of the volume of the insulator. The void fraction may be at between any of the aforementioned percentage values, with respect to the volume of the insulator, e.g., from about 35% to about 5%, or from about 10% to about 30%. The electrolyte may be disposed in the volume, e.g., in a space between the insulating material portions disposed in the volume of the insulator. The insulating material may or may not be porous, e.g., a particulate material of the dynamic insulator may be porous. The electrolyte in the volume of the dynamic insulator may facilitate conduction of the charge carriers. The dynamic insulator may be included in the battery, e.g., an integral and/or internal, component of the battery. The dynamic insulator may or may not be disposed in the dividing space, if present in the battery. The battery may include a housing comprising one or more cells, and a dynamic insulator may contact one or more sides of the cell. The dynamic insulator may contract the interior face(s) of the housing. The cell may be immersed in the electrolyte. The electrolyte may be disposed (a) between the electrodes, (b) in each of the electrodes such as in a space unoccupied by the material(s) forming the electrode, (c) in the separation space, (d) as part of the dynamic insulator, (e) in a space separating one cell from its immediately adjacent cell, or (f) any combination thereof. In normal operation of a cell, the current passing from one electrode to its opposing electrode, mainly passes through the separation space (and through the separator), with a residual current passing through the volume occupied by the dynamic insulator.

FIG. 6 shows schematic examples of insulators. In example 600, particulate matter comprising the insulating material, including particle 601, is disposed in electrolyte 602. In example 600, matrix 651 comprising the insulating material, is immersed in electrolyte 652.

In some cases, the cell experiences an ESC event when the cell is charged. During the ESC event, a larger electrical current (e.g., load current) passes between the opposing electrodes of the cell (e.g., between the cathode and the anode), e.g., during the ESC event, a larger number of charge carriers (e.g., Li+) pass through the separator and between the opposing electrodes through the separation space, e.g., from the anode to the cathode. Larger is compared to operation under the normal conditions. After consent of the ESC event, (e.g., eventually,) heat from the larger current may cause the separator to “shutdown,” blocking much of the ionic conductivity between the opposing electrodes, e.g., between the anode and the cathode. For example, there is a substantial reduction (e.g., cessation) of the load current. During the ESC event, a smaller electrical current can pass between the opposing electrodes (e.g., between the cathode and the anode); and (e.g., simultaneously) the charge carriers (e.g., Li+) can pass through the dynamic insulator (e.g., electrolyte therein) contacting the opposing electrodes of the cell. The smaller electrical current may be referred to herein as the “residual current”). The smaller (residual) current may be effectuated by the charge carriers passing through the insulator, unless the insulator curtails such passage, e.g., at least during the ESC event. The dynamic insulator can contact at least one side of the electrode, e.g., can contact at opposing side of the electrodes (e.g., at a direction normal to, or substantially normal to, the separation space), e.g., see FIG. 2, 200. In an example, the separator shut down may cause the larger current between the opposing electrodes of the cell to diminish, e.g., substantially and/or measurably cease. The shutdown in the current load may be due to one or more components in the separation space undergoing a change due to a triggering event occurring during the ESC, e.g., any triggering event disclosed herein. Without wishing to be bound to theory, the shutdown of the separator may be at least in part due to partial, or due to complete, melting of a material (e.g., physical, and/or chemical change) of the separator, e.g., at least in part due to the elevated temperature occurring during the increased heat. Without wishing to be bound to theory, the shutdown of the separator may be at least in part due to partial or complete melting of the separator, e.g., at least in part due to the elevated temperature during the increased heat. The increased heat may be caused at least in part by passing of the larger electrical current between the opposing electrode and through the separation space. The residual current may be propagating between opposing electrodes of the cell at the side of the electrodes, e.g., through the insulator. The insulator may or may not contact the separation space. At the side of the electrodes (e.g., electrode ends), the residual current propagates in a path from one electrode to its opposing electrode in the cell, and through the volume of the dynamic insulator contacting the two electrodes, e.g., see FIG. 2, 201. In such scenario, even though the separator will “shut down” to prevent an adverse effect caused by the load current (e.g., FIG. 2, 206), the adverse effect may occur at least in part due to flow of the residual current, which may trigger a runaway (e.g., exothermic) reaction causing the cell (e.g., and the battery) to adversely heat up, e.g., FIG. 1, 113. The adverse effect(s) may be adverse to the cell, to the battery, and/or objects disposed in the environment outside of the cell, whether animate or inanimate. The adverse effect(s) may be any of the ones disclosed herein. Outside of the cell can comprise outside of the battery housing, e.g., in an ambient environment. The adverse effect(s) may be defined according to jurisdictional definition where the battery is manufactured, stored, used, and/or otherwise located in. It may be advantageous to curtail (e.g., prevent) the occurrence of such adverse effect(s), e.g., using the dynamic insulator. In some embodiments, the present disclosure provides solutions to curtail the adverse effects. In some embodiments, the present inventions relate to method(s) (e.g., technique), device(s), apparatus(es), system(s), and design(s), which build a battery comprising cell(s). The battery may be configured to curtail the adverse effects, e.g., at least in part by shutting of the residual current and/or the load current which is in normal operation the main current of the battery.

In some embodiments, disclosed herein is a battery that uses a dynamic insulator comprising a material type (e.g., a polymer and/or a resin) to substitute at least a portion of the ceramic (e.g., aluminum oxide) in the insulator. The volume of the dynamic insulator may be referred to as a “porous volume,” or a “porous layer.” The dynamic insulator may be disposed on one or more faces of the cell. The face(s) of the cell may comprise opposing faces of the cell. The opposing faces of the cell may be opposing XY faces of a cell, opposing ZY faces of the cell, and/or opposing XZ faces of the cell. The dynamic insulator may be disposed in a volume in which residual current would flow when the dynamic insulator may be substituted by an insulator not susceptible to the triggering event, e.g., event triggered during the ESC. In some embodiments, the material type of the dynamic insulator is configured to be electrically insulating. In an example, the porous layer (the dynamic insulator) comprises a material type configured for electrical insulation. The degree of the electrical insulation of the dynamic insulator may be triggered by the triggering event, e.g., may be temperature dependent. The degree of electrical insulation of the dynamic insulator may depend on the triggering event, e.g., on the temperature of the dynamic insulator. The triggering event may cause the dynamic insulator to curtail its ability to conduct electrical current. The degree (e.g., rate) in which the charge particles flow in the dynamic insulator may depend on the triggering event, e.g., on the temperature. The dynamic insulator may comprise a polymer or a resin. One or more components of the dynamic insulator may have at least one material characteristic configured to be altered on the occurrence of the triggering event, e.g., beyond a threshold. In an example, the dynamic insulator may undergo a structural change (e.g., melt) above a temperature threshold. The material characteristic(s) depending on the triggering event(s) (e.g., on a threshold thereof) may comprise a change in a physical state of material, e.g., melting, or solidifying. The material characteristic(s) may depend on a threshold of the triggering event(s). The material characteristic(s) may comprise a change in the viscosity of a fluid material in the dynamic insulator, e.g., a chance in the viscosity of the electrolyte in the dynamic insulator. The change in material characteristic(s) may comprise a physical change or a chemical reaction. The change in material characteristic(s) may comprise binding, gelling, melting, or any combination thereof. Binding may comprise alteration of covalent bonds, ionic bonds, hydrogen bonds, and/or polar bonds. The alteration may comprise cross linking within a molecule (e.g., polymer strand), or between molecules (e.g., polymer strands), e.g., to form a matrix such as a gel. In an example, at least one component of the dynamic insulator may comprise cross branching. The physical shape (e.g., extent) of the molecule in the dynamic insulator may be temperature dependent. The polymer particles may have a (e.g., substantially) similar size and shape. The polymer particles may have a (e.g., substantially) homogenous size and/or shape distribution. The size and/or shape distribution of the particle may be a bell shape. In some embodiments, the dynamic insulator comprises a particulate material configured to be electrically insulating. The dynamic insulator and the separator may have at least one material type of the same type, e.g., and the material type may be different than the electrolyte. The dynamic insulator and the separator may differ by at least one material type. The particulate material of the insulator is configured to have similar (e.g., substantially the same, or the same) susceptibility to the triggering event as that of the (e.g., polymer) separator, e.g., same triggering event threshold. In some embodiments, the particulate material is configured to have similar (e.g., substantially the same, or the same) thermal properties as that of the (e.g., polymer) separator. The susceptibility of the dynamic insulator to the triggering event may allow inducing shutdown of the (e.g., alternate) residual current pathway. The susceptibility of the dynamic insulator to the triggering event may reduce an overall heating of the cell during an ESC event. The susceptibility of the dynamic insulator to the triggering event may curtail (e.g., prevent) one or more of the adverse effects. Such properties of the dynamic insulator may improve the overall safety of the cell and/or of the battery. The heating may comprise joule heating, e.g., resistive, or ohmic, heating in which heat is generated at least in part due to the resistance encountered by an electric current passing through a conductor. In an example, the porous layer formed by the polymer particles (the dynamic insulator) is also electrically insulating and allows for ionic conduction and has similar thermal properties as the polymer separator. In an example, one or more of the properties of the dynamic insulator allow for inducing shutdown of this alternate current pathway, reducing the overall Joule heating of the cell during an external short circuit and improving safety.

In some embodiments, the dynamic insulator comprises a particulate material, e.g., as disclosed herein. The particulate material may have a size distribution. The particulate material (e.g., powder) may have central tendency (e.g., average) of a FLS (e.g., diameter) of at least about 1.5 micron (μm), 2.5 μm, 3.5 μm, 5 μm, 8 μm, 10 μm, 12 μm, or 15 μm. The particulate material (e.g., powder) may have central tendency (e.g., average) of a FLS (e.g., diameter) between the aforementioned values, e.g., from about 1.5 micron (μm) to about 15 μm, or from about 1.5 μm, to about 12 μm. The central tendency (e.g., median particle size—SD50) of the particulate material of the dynamic insulator may be between the aforementioned values, e.g., from about 3.5 μm to about 5 μm, from about 5 μm to about 12 μm, or from about 7 μm, to about 19 μm. The size distribution may assume a bell shape. The shape of the particles may comprise spherical, rod-like, or disk-like. The particulate material may have (e.g., substantially) spherical particles. The particulate material may comprise amorphous particles. Particles of the particulate material may have a (e.g., substantially) similar size and/or shape. The polymer particles may have a homogenous size and/or shape distribution. In some embodiments, the dynamic insulator comprises a particulate material configured to be electrically insulating. The particles may be generated by a process comprising melt mixing and grinding, spray drying, or precipitation and drying.

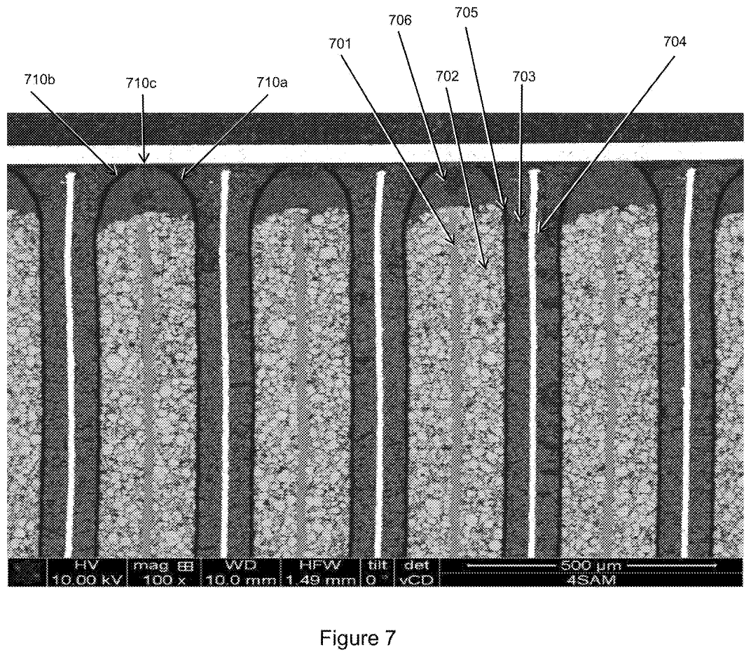

As shown in the examples of FIGS. 7-9 and discussed herein, an example of a (e.g., secondary) battery uses aluminum oxide (“alumina” or AO) to create a dynamic insulator (also herein “porous layer”) on both XY faces of a cell. During an external short circuit (ESC) of a charged battery, a larger electrical current (also herein “load current”) passes between the electrodes (e.g., between the cathode and the anode). Simultaneously, charge carriers such as lithium ions pass through the separation space (e.g., and through the separator) while traveling from the anode to the cathode. In some examples, (e.g., eventually), the heat from the large (load) current causes the separator to “shutdown,” blocking much of the ionic conductivity between the anode and the cathode. However, at the Z end of the electrodes, there is still a current path through the porous AO. As shown in FIGS. 7-9, some examples of (e.g., secondary) batteries have a “horizontal” arrangement, which means that there is a much larger path for such side (e.g., edge) current (e.g., residual current) as compared to the residual current in a wound cell configuration (e.g., FIG. 1, 115, and FIG. 3, 300), or “vertical” stacked cells (e.g., FIG. 3, 330)—this may result in a substantial (e.g., larger) residual current after shutdown as compared to other secondary cell architectures. The cells may be disposed in a pouch of the battery.

FIG. 7 shows a cross section of a battery comprising anode 702 comprising silicon and carbon (e.g., a composite of Silicon and carbon) coupled with current collector 701. The anode contacts separation space 705. One face of the separation space faces anode 702, and its opposing face faces and contacts cathode 703 comprising metal oxides (e.g., comprising lithium). Current collector 704 is coupled with cathode 703. The separation space (e.g., 705), extends beyond (e.g., outside) of the side (e.g., edge) of the anode, and bends 710a towards the anode's interior. The anode contacts the separation space on its face, and a dividing space at its opposing face. The dividing space extends beyond the face of the anode that it contacts. The dividing space bends 710b towards the anode's interior and towards the separation space. An insulator 706 (e.g., comprising alumina) contacts the sides (e.g., edges) of the cell, e.g., the sides (i) of the anode, (ii) of the cathode, (iii) of the separation space, and (iv) of the dividing space. Separation space 705, 710a, and dividing space 710b, are (e.g., substantially) identical e.g., in terms of their material content and/or general physical dimensions. Particulate material is depicted in anode 702, in cathode 703, and in insulator 706. In the example shown in FIG. 7, the dividing space and the separation space (e.g., substantially) mirror each other, along an axis running through a long axis of the anode depicted in FIG. 7, e.g., along the current collector of the anode disposed along the long axis. The Dividing space and the separation space are separated from each other by gap 710c. The dividing space divides one battery cell from another. The dividing space may comprise (e.g., substantially) the same material as the separation space. In the example shown in FIG. 7, the battery comprising cells arranged in a ABCS repeating arrangement, wherein A=anode, B=separation space, C=cathode, and S=dividing space. In the example shown in FIG. 7, the anode has a cross section that is longer than the cross section of the cathode, the thickness being in a direction substantially perpendicular to the long axis of the cathode depicted in FIG. 7.

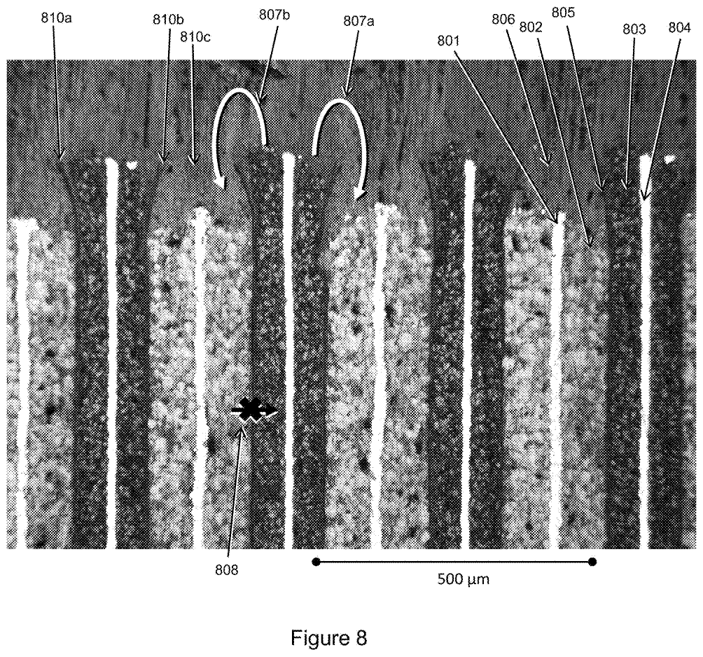

FIG. 8 shows a cross section of a battery comprising anode 802 comprising silicon and carbon (e.g., a composite of Silicon and carbon) coupled with current collector 801. The anode contacts separation space 805, e.g., comprising a separator. One face of the separation space faces anode 802, and its opposing face faces and contacts cathode 803 comprising metal oxides (e.g., comprising lithium). Current collector 804 is coupled with cathode 803. The separation space (e.g., 805), extends beyond the side (e.g., edge) of the anode, and bends 810a towards the anode's interior. The anode contacts the separation space on its face and contracts a dividing space at its opposing face. The dividing space extends beyond the face of the anode that it contacts. The dividing space bends 810b towards the anode's interior and towards the separation space. An insulator 806 (e.g., comprising alumina) contacts the sides (e.g., edges) of the cell, e.g., the sides of the anode, of the cathode, of the separation space, and of the dividing space. Particulate material is depicted in anode 802, in cathode 803, and in insulator 806. In the example shown in FIG. 8, the dividing space and the separation space (e.g., substantially) mirror each other, along an axis running through a long axis of the anode depicted in FIG. 8, e.g., along the current collector of the anode disposed along the long axis. The Dividing space and the separation space are separated from each other by gap 810c. The dividing space divides one battery cell from another. The dividing space may comprise (e.g., substantially) the same material as the separation space. In the example shown in FIG. 8, the battery comprising cells arranged in a ABCS repeating arrangement, wherein A=anode, B=separation space, C=cathode, and S=dividing space. When excessive load current and/or heat is experienced in the battery cell, the load current shuts off 808. Without wishing to be bound to theory, this may be due to changes occurring in the separation space such as clogging of the separator pores by a molten separator material. While load current 808 shuts off, residual currents 807a and 807b may continue to preside in the battery, e.g., when the insulator is not a dynamic insulator susceptible to the triggering conditions, or triggering event, e.g., of a runaway reaction.

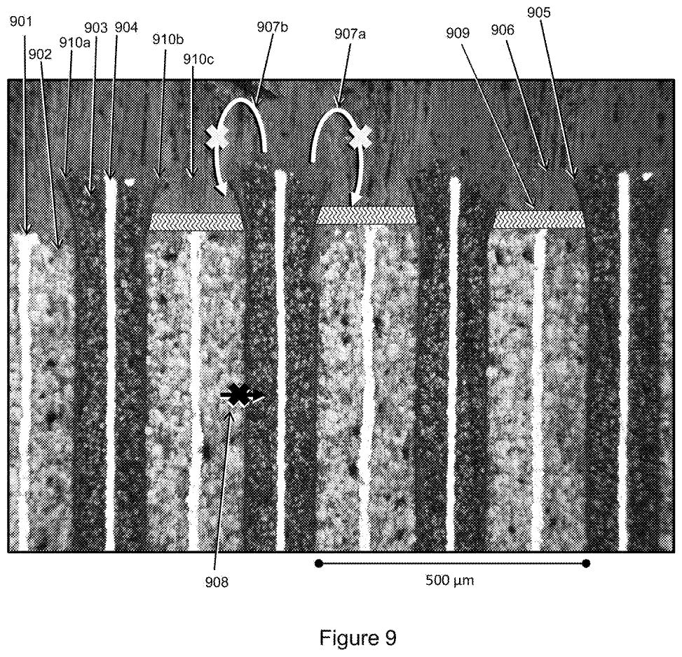

FIG. 9 shows a cross section of a secondary battery cell having a dynamic insulator that was deposited as a polymer particle paste, the polymer particles being in the dynamic insulator volume 906 instead of non-dynamic insulator comprising a ceramic insulator such as aluminum oxide (AO), the paste utilized to create the insulator (also herein “porous layer”) on both XY faces of a cell, e.g., see FIG. 3, 350. The particles of the polymer particle paste have similar (e.g., substantially the same) size and shape as those of the ceramic (e.g., alumina=AO) paste. The porous layer formed by the polymer particles is (A) (also) electrically insulating, (B) allows for ionic conduction (e.g., at least in part by the electrolyte immersed in the volume of the dynamic insulator), and (C) has similar (e.g., substantially the same) thermal properties as the polymer separator. Once the separator shuts down (e.g., via melting), the polymer particle paste also shuts down (e.g., melt), effectively shutting down the (e.g., hypothesized) edge (e.g., residual) current pathway of the residual current. Shutting down may be with relation to a cessation of the current flow, e.g., to a substantial, material, and/or measurable degree. Material cessation of the current is such that the current may not be able to effectuate a requested/prescribed function effectuated by the current. For example, the melted polymer particles fuse and block the residual ionic conductance. In some embodiments, these properties of the dynamic insulator shown in the example of FIG. 9, allow for inducing shutdown of this alternate current pathway (e.g., the residual current pathway), such as by reducing the overall Joule heating of the cell during an external short circuit and improving safety.

FIG. 9 shows a cross section of a battery comprising anode 902 comprising silicon and carbon (e.g., a composite of Silicon and carbon) coupled with current collector 901. An anode contacts a separation space having bent portion 910a, e.g., comprising a separator. Another example of a separation space is 905. One face of the separation space faces anode 902, and its opposing face faces and contacts a cathode 903 comprising metal oxides, e.g., comprising lithium. Current collector 904 is coupled with cathode 903. The separation space (e.g., 905), extends beyond the side (e.g., edge) of the anode, and bends 910a towards the anode's interior. The anode contacts the separation space on its face and contracts a dividing space at its opposing face. The dividing space extends beyond the face of the anode that it contacts. The dividing space bends 910b towards the anode's interior and towards the separation space. A dynamic insulator 906 (e.g., comprising a polymer) contacts the sides (e.g., edges) of the cell, e.g., the sides of the anode, of the cathode, of the separation space, and of the dividing space. Particulate material is depicted in anode 902, in cathode 903, and in the dynamic insulator 906. In the example shown in FIG. 9, the dividing space, and the separation space (e.g., substantially) mirror each other, along an axis running through a long axis of the anode depicted in FIG. 9, e.g., along the current collector of the anode disposed along the long axis. The Dividing space and the separation space are separated from each other by gap 910c. The dividing space divides one battery cell from another. The dividing space may comprise (e.g., substantially) the same material as the separation space. In the example shown in FIG. 9, the battery comprising cells arranged in a ABCS repeating arrangement, wherein A=anode, B=separation space, C=cathode, and S=dividing space. When excessive load current and/or heat is experienced in the battery cell, the load current shuts off 908. Without wishing to be bound to theory, this may be due to changes occurring in the separation space such as clogging of the separator pores by a molten separator material. While load current 908 shuts off, residual currents 907a and 907b also shut off, e.g., as the dynamic insulator and the separator comprise (e.g., substantially) the same material susceptible to increased temperature. The alteration in the property/properties of the dynamic insulator due to the triggering event (e.g., elevated temperature) is schematically depicted as block 909. However, any portion of the dynamic insulator 906 experiencing the triggering event may experience the change.

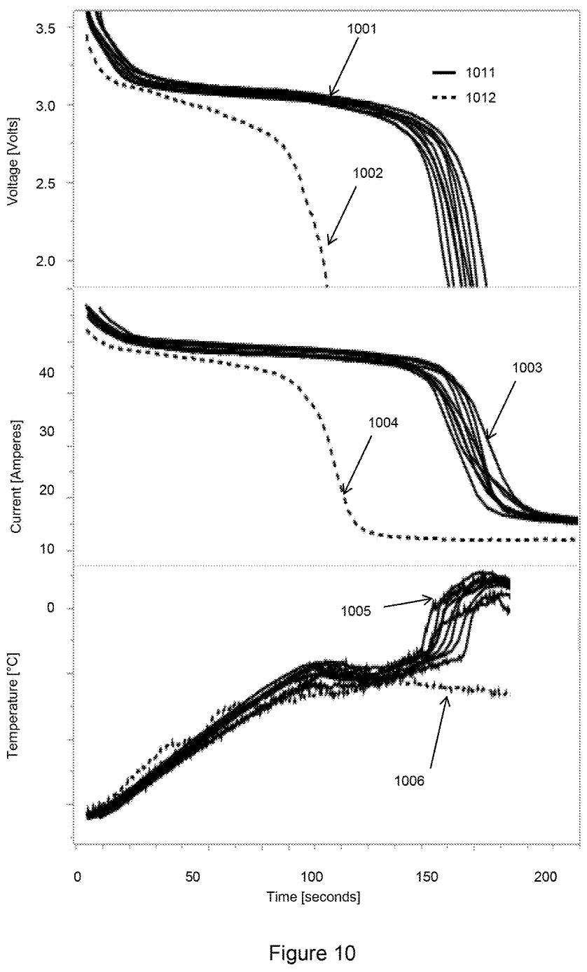

FIG. 10 shows example of time dependent graphs showing voltage, current, and temperature of batteries. Graphs having solid line 1011 show batteries in which the cells are stacked in an arrangement similar to the one depicted in FIG. 13, 1300. The graphs having broken line 1012 show batteries in which the cell is rolled in a wound cell (e.g., jelly roll) type arrangement similar to the one depicted in FIG. 13, 1350, or FIG. 3, 300. The batteries utilized to generate the graphs in FIG. 10 do not have a dynamic insulator. The graphs 1011 are taken during discharging of the stacked cell battery experiencing an adverse effect. While the voltage 1001 and current 1003 experience a significant drop (e.g., due to a load current shut down), the temperature 1005 of the battery significantly increases, e.g., due to flow of the residual current. The significant temperature increase may be due to a resulting runaway reaction. Without wishing to be bound to theory, the increase in the runaway reaction in the stacked cell configuration corresponding to 1011, may be at least in part due to an increased residual current as compared to the residual current in the jelly roll type battery corresponding to 1012. In the jelly roll type battery, while the voltage 1002 and current 1004 experience a significant drop (e.g., due to a load current shut down), the temperature of the battery remains substantially constant 1007, e.g., possibly due to the lower residual current as compared to the residual current.

In some embodiments, the dynamic insulator comprises a polymer. A polymer past may be utilized to form the dynamic insulator. The polymer particle (e.g. and paste thereof) may comprise polyethylene (PE), polypropylene (PP), polyvinylidene halogen, or any combination thereof. The dynamic insulator may comprise any other similar polymer having insulation properties and/or a melting temperature to the separator, e.g., any polymer disclosed herein, as applicable. The triggering event of the dynamic insulator may be a threshold temperature such as a melting temperature. The malting temperature of a material in the dynamic insulator may be in the range of from about 100 degrees Celsius (°C) to about 150 °C. A paste of an insulating material of the dynamic insulator may be deposited during the (e.g., same or substantially the same) procedures used to deposit a non-dynamic insulator such as a ceramic insulator devoid of a material triggered by the triggering event. The process may comprise a mask process and/or a print process such as a stencil print process. The process may comprise any suitable process disclosed herein. In an example, the polymer particle paste is deposited using a mask process and/or a print process such as a stencil print process. The polymer particle paste can be deposited using the (e.g., same, or substantially the same) procedures used to deposit the AO paste. In an example, the polymer particle paste is deposited using a mask process and/or a print process such as a stencil print process.

In some embodiments, the dynamic insulator undergoes a transition due to a triggering event. The triggering event may comprise (a) a temperature threshold, (b) a concentration threshold of the charge carriers, or (c) a flow rate of the charge carriers. The triggering event may occur (a) just before, (b) at the onset of the runaway reaction, or (b) just before the runaway reaction will cause the adverse effect(s) such as the substantial damage. Just before the runaway reaction may comprise (A) at the current plateau coupled with a steep temperature increase (e.g., FIG. 1, 101 and 111), or (B) at a steep current decrease coupled with a temperature plateau (e.g., FIG. 1, 102 and 112). The triggering event may be of material type(s) within the dynamic insulator. The material type(s) may comprise an insulating material, an electrolyte, or an attractor. At least one material type of the dynamic insulator may be susceptible to the triggering event cause a substantial and/or material change in the material type(s). The susceptibility of the material type(s) may depend at least in part on (a) a temperature threshold, (b) a concentration threshold of the charge carriers, or (c) a flow rate of the charge carriers. The material type(s) may undergo a change in one or more material properties based at least in part on a threshold of the triggering event type(s). The threshold (e.g., temperature) may be of a transition of the insulating material within the dynamic insulator. The transition may comprise any transition disclosed herein affecting a material. The transition may be of at least one material property, e.g., physical and/or chemical properties. The transition may comprise a phase transition. The transition may be at a threshold condition. In an example, the transition may be at a temperature comprising a melting temperature, a connecting (e.g., melting or fusing) temperature, or a glass transition temperature. The transition may comprise a transition of an electrolyte and/or other solvent, e.g., within the dynamic insulator. The transition may comprise a three-dimensional (3D) reconfiguration, a cross linking, a gelling, or any combination thereof. The property change(s) may cause the charge carriers to alter (e.g., curtail) their propagation rate within the dynamic insulator, e.g., within a volume thereof.

In some embodiments, the dynamic insulator is configured to curtail the residual current in a cell. In some embodiments, the dynamic insulator is configured to curtail current running in the dynamic insulator. In some embodiments, the dynamic insulator is configured to curtail (e.g., reduce) currents running outside of the separation space disposed between two opposing electrodes of a cell. The dynamic insulator may curtail (e.g., shut off) currents propagating (e.g., having a path) around the separator, and/or around the separation space. The insulating material of the dynamic insulator may contact (e.g., coat) one or more faces of the cell. The insulating material may be (e.g., substantially) excluded from an interior of the cell, e.g., the insulating may be excluded from the separation space. The insulating material may be excluded from most the separation space, e.g., comprising at most about 10%, 5%, or 2% of the separation space. The separation space may be defined by a volume within the exterior faces (e.g., envelope) of the separator. The insulating material may contact cell component(s) comprising the anode, the cathode, the separation space, or the separator. The dynamic insulator may be configured to curtail the runaway (e.g., exothermic) reaction, e.g., at least in part by being configured to poison the runaway reaction upon occurrence of triggering event(s). The electrolyte of the dynamic separator may seep into, occupy, and/or adhere to (e.g., wet) the cell component(s). Liquids of the dynamic insulator may seep between particles of the electrode. The cathode may comprise metal oxide(s). The anode may comprise an allotrope of elemental carbon, or silicon, e.g., in particle form. The allotrope of elemental carbon may or may not be conductive. The allotrope of elemental carbon may comprise amorphous carbon, carbon foam (e.g., nanofoam), or Z-ACA allotrope. The allotrope of elemental carbon may comprise graphite, carbon fiber, hard carbon, graphene, carbon nanotube, or fullerene. The anode may comprise silicon particles embedded in a carbon matrix, or a mixture of silicon particles and carbon particles. The cathode material may be deposited on a metal sheet, e.g., having a thickness of at most about 6 millimeters (mm), 5 mm, 2.5 mm, 1 mm, or 0.5 mm. The sheet may be a foil, e.g., having a thickness of at most about 0.4 mm, 0.2 mm, or 0.1 mm. The anode material may be deposited on a metal sheet. The metal sheet of the anode and of the cathode may be (e.g., substantially) of the same material type. The metal sheet of the anode and of the cathode may be of different material types. The metal sheet may comprise an elemental metal or a metal alloy. The metal sheet may comprise aluminum, titanium, nickel, stainless steel, or copper. In an example, the cathode material is deposited on a copper sheet, and the anode material is deposited on an aluminum sheet.

In some embodiments, the dynamic insulator may comprise particulate material. The particulate material may be configured to connect at the occurrence of the triggering event, e.g., a triggering threshold such as a temperature threshold. The particulate material may be configured to connect (a) before, (b) at the onset of the runaway reaction, or (b) before the runaway reaction will cause the adverse effect(s) such as the substantial damage. Connection of the particulate material may comprise melting, fusing, sintering, or otherwise binding. In some embodiments, connection of the particulate material is configured to curtail the flow of the charge carriers through the dynamic insulator, e.g., from one electrode to its counter electrode.

In some embodiments, the battery is exposed to the triggering event(s). When the battery experiences the triggering event (e.g., for a sufficiently prolonged time), or when conditions more adverse than the triggering event, the adverse effect(s) may occur. The adverse effects may include the substantial damage. The triggering event may comprise a temperature rise within the dynamic insulator. The rise in temperature in the dynamic insulator may be due to a rise in temperature in the battery and/or in the battery cell, e.g., during its use (e.g., operation), shipping, its storage, its maintenance, or during its pre-charging (e.g., buffering). The pre-charging may comprise buffering charge carriers (e.g., metal ions) into the anode, e.g., to increase the cell's performance. The substantial damage may prevent the battery and/or the affected cell, from operating, e.g., as it/they would operate during the normal conditions. Normal conditions may be according to the specification of the battery, the cell, and/or according to a requested performance thereof. The substantial damage may be to the cell, to the battery, to object(s) in an ambient environment external to the battery, any combination thereof, any other substantial damage disclosed herein, or any other adverse effect disclosed herein. The object(s) may comprise an animated object, or an inanimate object, e.g., personnel in an ambient environment external to the battery. The substantial damage may be caused at least in part by the cell and/or battery, catching fire.

In some embodiments, the battery comprises a dynamic insulator. Material(s) of the dynamic insulator may undergo a transition initiated at a triggering event. The transition may cause the charge carriers to curtail (e.g., cease) their propagation rate through the separator space and/or through the separator. The transition may comprise melting, fusing, sintering, otherwise binding, or any other transition disclosed herein. The location of the dynamic insulator within the battery and/or the (material) nature of the particles, may allow the cell to heat up to a maximal temperature that curtails the adverse effect(s) that would occur without the presence of the dynamic insulator. The insulating material in the dynamic insulator may substitute, or be added to, a ceramic such as alumina. The dynamic insulator may be disposed externally to the cell (e.g., electrode-separator-cathode construct) and internal to the battery housing. The insulating material may comprise material type(s). The insulator may comprise the type insulating material of the separation space such as of the separator. The insulating material of the dynamic insulator may be comprised of at least one material type different from the material included in the separation space such as the separator. The insulating material may comprise a polymer, or a resin. The polymer may comprise a polyolefin. The polymer may comprise polyethylene (PE), polypropylene (PP), or polyvinylidene halogen. The halogen may comprise fluoride, chloride, or bromide. The polyvinylidene may comprise one or more halogen types. The insulating material may comprise a fire retardant. The insulating material may comprise of material having a small number of, or no, polar groups. The polar groups may comprise hydroxy, acid, ketone, aldehyde, thiol, or phosphine, e.g., primary phosphine. Small number is relative (a) to the number of repeating units, and/or (b) to the number of carbon atoms in the resin. Small number is relative (a) to the number of repeating units, and/or (b) to the number of atoms in the backbone of the polymer. The small number may be at a percentage of at most about 45%, 40%, 30%, 20%, 10%, or 5% relative to the number of (a) repeating units of the polymer, (b) atoms in the backbone of the polymer, or (c) carbon atoms in the resin. The insulating material may comprise an organic molecule, or a silicon-based molecule. In an example, the insulating material comprises an organic molecule. The battery may undergo one or more heat treatments during its manufacture. The maximal temperature of the heat treatment(s) may be at most about 50 degrees Celsius (°C), 60 °C, 70 °C, or 75 °C. The separator may have a transition point, e.g., of at least about 120 °C, 130 °C, 140 °C, 150°, or a higher temperature. The transition point may be susceptible to temperature. The transition point may comprise melting or glass transition. The dynamic insulator may comprise material(s) undergoing a transition, e.g., at a triggering event comprising the temperature. The triggering event may comprise a point or a range. The transition may have a threshold, e.g., a value or a range. The threshold temperature of the dynamic insulator and/or of the insulating material, may be at least about 70 °C, 75 °C, 80 °C, 90 °C, 100 °C, 110 °C, 120 °C, 130 °C, 140 °C, 150°, or a higher temperature. The threshold temperature of the dynamic insulator and/or of the insulating material, may be at most about 200 °C, 180 °C, 150 °C, 140 °C, 130 °C, 120 °C, or a lower temperature. The threshold temperature of the dynamic insulator and/or of the insulating material, may be between any of the aforementioned values, e.g., from about 70 °C to about 200 °C, from about 80 °C to about 130 °C, from about 70 °C to about 90 °C, from about 90 °C to about 150 °C, from about 100 °C to about 180 °C. The minimal temperature at which dividing space undergoes the transition triggered by a triggering event comprising temperature, may be at least at the threshold temperature at which the separator undergoes a transition (e.g., melting) or at a higher temperature. The threshold temperature may be the plateau temperature before the runaway reaction initiates. The threshold temperature may be above that plateau temperature. The threshold temperature may be just before, or when, the runaway reaction initiates, e.g., the “just before” as defined herein such as with respect to FIG. 1. The threshold temperature may be (e.g., just) before the adverse effect(s) occur. In some embodiments, the dynamic insulator comprises at least one type of material susceptible to temperature. The susceptibility may comprise any threshold disclosed herein. The thermal susceptibility of the dynamic insulator may allow inducing shutdown of the (e.g., alternate) residual current pathway. Thermal susceptibility of the dynamic insulator may reduce the overall heating of the cell during an ESC event. The thermal susceptibility of the dynamic insulator may cause the residual current to (e.g., substantially) shut down before, after, or during shutting down of the load current. The dynamic insulator may comprise at least one material type configured to curtail (e.g., slow down the rate of) the diffusion of the charge carriers across the dynamic insulator, as a function of the triggering event. In an example, the triggering event is a threshold temperature, e.g., and curtailing the charge carriers'diffusion is at or above the temperature threshold. Upon reaching, or exceeding, the triggering event threshold, the dynamic insulator may form at least a partial (e.g., a complete) barrier to transport the charge carriers from one electrode to its opposing electrode. At least one material type of the dynamic insulator may be configured to reduce (e.g., deter) occurrence of, or reduce the degree of, one or more of the adverse effects of the battery in which it is disposed. At least one material type of the dynamic insulator may be configured to curtail (e.g., deter or reduce) the occurrence of, or curtail the degree of, the runaway reaction. In an example, at least one material type of the dynamic insulator is configured to curtail the degree of the heat generated in the battery to (e.g., substantially) equal the heat dissipating from the battery. In an example, at least one material type of the dynamic insulator is configured such that upon heating, the battery will reach a maximum temperature, e.g., steady state temperature or equilibrium temperature. The maximum temperature may be an equilibrium between heat dissipation from the battery and heat formation in the battery. The maximum temperature may be below one or adverse effects, e.g., substantial and/or material adverse effects such as any of the ones disclosed herein. The maximum temperature may be such that the heat generated by the battery is controllable, e.g., manageable. Controllable may be in an ambient setting, under reasonable effort, and/or under reasonable operation conditions such as allowed in the jurisdiction. The maximum temperature may be such that the rate of the heat generation in the battery is controllable, e.g., manageable. The dynamic insulator may curtail the heat generation in at least one component of the battery, e.g., and in the cell. Curtailing the heat generation may comprise deterring, slowing, halting, or stopping, that heat generation. The dynamic insulator may be configured to curtail propagation of the charge carriers through the dynamic insulator, e.g., from one electrode to its opposing electrode in a cell. The dynamic insulator may be configured to undergo a change in one or more material properties of material(s) of the dynamic insulator. The change may be triggered by a triggering event comprising: a temperature rise, an increased rate of the charge carriers through the dynamic insulator, or an increased concentration of the charge carriers through the dynamic insulator. The battery cells covered by the insulator, may be disposed in a housing. The battery cells covered by the insulator may be disposed in a pouch disposed in a housing. The housing may comprise a brace (e.g., constraint) that may curtail the cell's expansion in at least one Cartesian direction, e.g., during use of the cell. The housing may comprise a constraint curtailing expansion of the cell (e.g., of the cell set) in at least one Cartesian direction. Expansion of at least one cartesian direction may be curtailed by the brace more than at least one other direction. The brace may curtail expansion of the cell set more in the stacking direction of the cells in the set (e.g., X direction), as compared to other directions, e.g., as compared to one or more directions normal to the stacking direction (e.g., Z and Y direction). The brace may curtail expansion of the cell more in one direction normal to the stacking direction (e.g., Z), as compared to another direction normal to the stacking direction (e.g., Y). The brace may be disposed in the pouch, or outside of the pouch. The pouch and/or the housing, may be configured to retain the electrolyte in the interior of the pouch. The battery may or may not comprise the pouch. The pouch and/or the housing, may be configured to insulate the cells from at least one reactive agent in the ambient environment. The reactive agent may be configured to cause corrosion, short circuit, runaway reaction, and/or other chemical reaction. The other chemical reaction may generate harmful gases (e.g., hydrogen). The reaction may be to metals or metal ions in the cell. At times, the temperature of the triggering event is measured outside of the battery cell, e.g., at the battery pouch and/or at the battery housing. At times, the temperature of the triggering event is measured inside the battery cell. The temperature can be measured using a thermocouple. The temperature inside the cell can reach at most about 20 °C, 30 °C, 40 °C, or 50 °C higher than the temperature outside of the battery cell, e.g., at the battery pouch, or the battery housing.

In some embodiments, the triggering event may cause a transition of an attractor of the dynamic insulator. The attractor may be configured to bind at least one charge carrier type, e.g., reversibly or (e.g., substantially) irreversibly. Irreversibly may be during the prescribed lifetime of the cell and/or of the battery. The charge carrier may have a strong affinity to a binding site of the attractor. The charge carrier may have a high binding constant to binding site(s) of the attractor. The attractor may comprise a polar group, e.g., as disclosed herein. The polar group may comprise ions, lone pair electrons, or labile atoms. The polar groups may comprise cations. The polar groups may have an atom (e.g., hydrogen) that is labile, e.g., for participation in a hydrogen type bond. The attractor may comprise a chelating group. The attractor may have a higher affinity with the charge carrier. The affinity may depend at least in part on (a) a temperature threshold, (b) a concentration threshold of the charge carriers, or (c) a flow rate of the charge carriers. For example, the attractor may be positively charged at or above the threshold temperature. For example, the binding groups of the attractor may be more exposed to the charge carriers at or above the threshold temperature.

In some embodiments, a dynamic insulator is added to the cell, e.g., during battery manufacturing. The dynamic insulator may be added as a precursor. The precursor may comprise a homogenous mixture, or a slurry, of the insulating material(s). The precursor may be applied on the surface of the cell(s), e.g., at one or mor of their sides, such as the ZX opposing sides of the battery depicted in FIG. 3, 330, or 350. The application may comprise printing, stenciling, or heat transfer. The application may comprise deposition. The printing may comprise stencil printing, direct printing, or sublimation printing. The direct printing may comprise additive manufacturing. The deposition may succeed forming the anode-separator-cathode construct. The application may succeed condensing the cell(s) such that they will fit into the battery housing. The application may succeed folding, rolling, or otherwise packing, of the cell(s). The application of the dynamic insulator may precede placing the cells into a battery housing, a harness (e.g., constraint), or any combination thereof. The harness may curtail (e.g., hinder, limit, or prevent) expansion of the battery, e.g., during its operation. The harness may be metallic. The harness may comprise stainless steel, Inconel, Monel, Hastelloy, Aluminum alloy (e.g., 6061), or high strength low allow steel (HSLA). The alloy may have weight, density, and/or strength like that of stainless steel, e.g., 300 series comprising 301, 304, or 316. The harness wherein the constraint comprises a material compatible with the electrolyte. The manufacturing process of the battery may be directed by a control system. At least a portion of the manufacturing process of the battery may be performed in an environment different by one or more characteristics from the ambient environment. The one or more characteristic may be a reduced amount of the reactive agent(s), e.g., as disclose herein. In an example, at least a portion of the manufacturing process of the battery takes place in a dry air, nitrogen, or argon environment. The dry air may comprise clean dry air (CDA). The manufacturing process may be performed in ambient pressure and/or temperature.

In some embodiments, the system, device, and/or apparatus disclosed herein comprises a control system. The control system may comprise one or more controllers. The control system may comprise, or be operatively coupled with, one or more devices, apparatuses, and/or systems of the mechanism (e.g., system, device, or apparatus) disclosed herein, including any component of the device(s), apparatuses(s), and/or system(s). The controller(s) may comprise, or be operatively coupled with, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a control system. A control system may comprise a laser control system. The controller may comprise a feedback control scheme. The feedback control scheme may comprise an open feedback loop control scheme. The feedback loop control scheme may comprise a closed feedback loop control scheme. The feedback control scheme may comprise hardware compensation. The feedback control scheme may comprise software compensation. The control system may comprise, or be operatively coupled with, a metrological detection system and configured to receive measurement data from the metrological detection system. The control system may be configured to generate control signals responsive to the measurement data collected by the metrological detection system.

In some embodiments, the systems, apparatuses, devices, and/or components thereof disclosed herein comprise one or more controllers. The one or more controllers can comprise one or more central processing unit (CPU), input/output (I/O) and/or communications module. The CPU can comprise electronic circuitry that carries out instructions of a computer program by performing arithmetic, logical, control and I/O operations specified by the instructions. The controller can comprise a suitable software (e.g., operating system). The control system may optionally include a feedback control loop and/or feed-forward control loop. The controllers may be shared between one or more systems or apparatuses. Each apparatus or system may have its own controller. Two or more systems and/or their components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller system may comprise a single input single output controller (SISO) or a multiple input multiple output controller (MIMO). The controller may interpret the input signal received. The controller may acquire data from one or more sensors. Acquiring may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer.

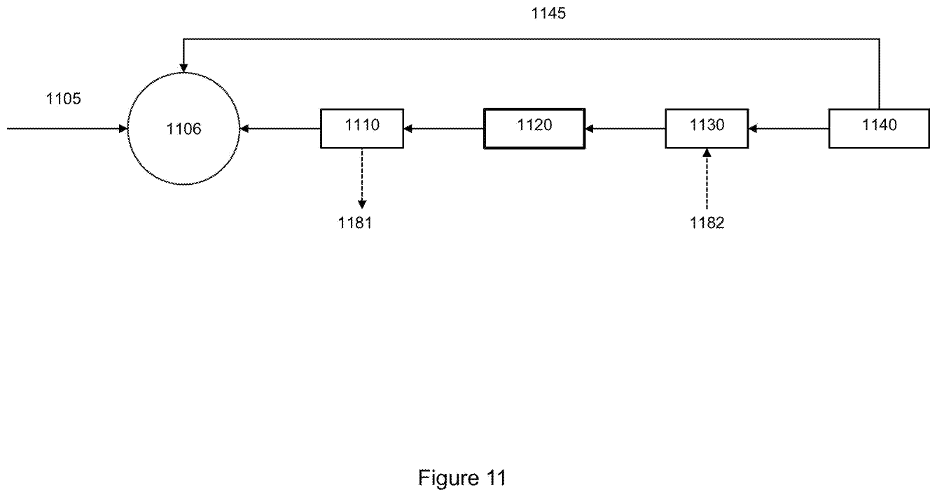

FIG. 11 shows a schematic example of process 1120 controlled using a control system in a feedback loop control scheme, e.g., in a closed loop control scheme. The control system receives set point 1105 to comparator 1106 that generates an error signal, which is fed 1145 into controller 1140. In other control systems, the comparator can be part of the controller. Controller 1140 generates a control signal that is fed into controlling element 1130. The controlling element may comprise a mechanism utilized for its control function to control process 1120. Controlling element 1130 provides an input to process 1120. The mechanism may effectuate a physical and/or a chemical change, which change is the input to process 1120. The physical change may comprise mechanical change, magnetic change, electromagnetic change, piezoelectric change, electrical change, pressure change, or temperature change. The chemical change may comprise a change in a chemical gradient, or in a chemical entity. Process 1120 can be any process disclosed herein, e.g., any method such as a fabrication (e.g., manufacturing) method. Process 1120 generates an output detected by measuring element 1110, e.g., using its sensor(s). The output provided by process 1120 may be a reaction of the process to the input provided by control element 1130. Measuring element 1110 generates a variable amplitude signal that is fed back into comparator 1106 and is again compared with the setpoint. Measuring element 1110 optionally also generates a controlled variable 1181. Control element 1130 optionally also receives a manipulated variable 1182, e.g., from an external source such as a processor and/or a communication system. Sensor(s) can be used by measuring element 1110 for the measurement of parameters of the process, e.g., 1120. The sensor measurement can be a determination of an amplitude of a parameter such as of a material, e.g., as disclosed herein. In an example, the value of the measurement is consistent and repeatable. The sensor(s) can convert the physical parameters (e.g., repeatedly, and reliably) into a usable form by the control system, e.g., into an electrical signal such as in a digital form. The comparator can perform an error detection, e.g., by determining a difference between the amplitude of the measured variable and a requested set reference point (e.g., set point 1105), which difference is the error signal. The error signal can be amplified and/or conditioned such as filtered. The signal amplification and/or conditioning may be performed by an external component to the controller (e.g., 1140), or within the controller. The reference point (e.g., set point) can be stored in the memory of the controller, or of a memory operatively coupled with the controller. The controller can be a (e.g., micro-) processor-based system that can determine the next operation to be taken in a process. The process may be sequential. The controller may evaluate the error signal in a continuous process control system, e.g., to determine what action is to be taken. The controller (e.g., 1140) can condition the signal, or be operatively coupled with a unit conditioning the system. Conditioning the signal may comprise noise filtering. Conditioning the signal may comprise correcting the signal for a non-linearity in the sensor. The controller may include the parameters of the process input control element. The controller may condition the error signal to direct the control element, e.g., 1130. The controller can monitor input signal(s). The input signals may be interrelated. The controller may be configured to direct at least two control elements in concert. The controller may be configured to direct at least two control elements simultaneously. The controller may be configured to direct at least two control elements sequentially. The control element (e.g., 1130) can be a device that controls an incoming material to the process, or any other attribute of the process comprising physical attribute or chemical attribute. The physical attribute may comprise mechanical, magnetic, piezoelectric, electromagnetic, electrical, pressure, or temperature attribute. The chemical attribute may comprise a chemical gradient, or in a chemical entity. The control element can be a flow control element. The control element can be a temperature control element. The control element can have toggle (e.g., On/Off) characteristics. The control element can provide linear, or non-linear, control of the control element. The control element can be used to adjust the input to the process, e.g., bringing the output variable to the value of the set point. The measuring element (e.g., 1110) can consist of sensor(s) to measure the physical property of a variable, a transducer to convert the sensor signal into an electrical signal, and/or a transmitter to amplify the electrical signal. The amplification of the signal can be transmitted with minimal (e.g., without measurable) loss. The control element may comprise an actuator which changes the electrical signal from the controller into a signal to operate and/or control a physical device such as a valve. The controller may comprise a memory or be operatively coupled with a memory. The control system may comprise a summing circuit, e.g., to compare the set point to the sensed signal, so that it can generate the error signal. The summing circuit may be part of the comparator. The controller may use the error signal to generate a correctional signal to control the control element. In an example, the controller controls a valve via an actuator and the input variable. The sensors of the measuring element may comprise optical sensors, temperature sensors, pressure sensors, chemical sensors, proximity sensors, viscosity sensors, chemical sensors, or any other sensor disclosed herein. The chemical sensors may sense a material comprising oxygen, water, or any other reactive agent(s) herein. The sensors may be configured to sense one or more attributes of the methods disclosed herein such as the fabrication methods.

Control may comprise regulate, modulate, adjust, maintain, alter, change, govern, manage, restrain, restrict, direct, guide, oversee, manage, preserve, sustain, restrain, temper, or vary.

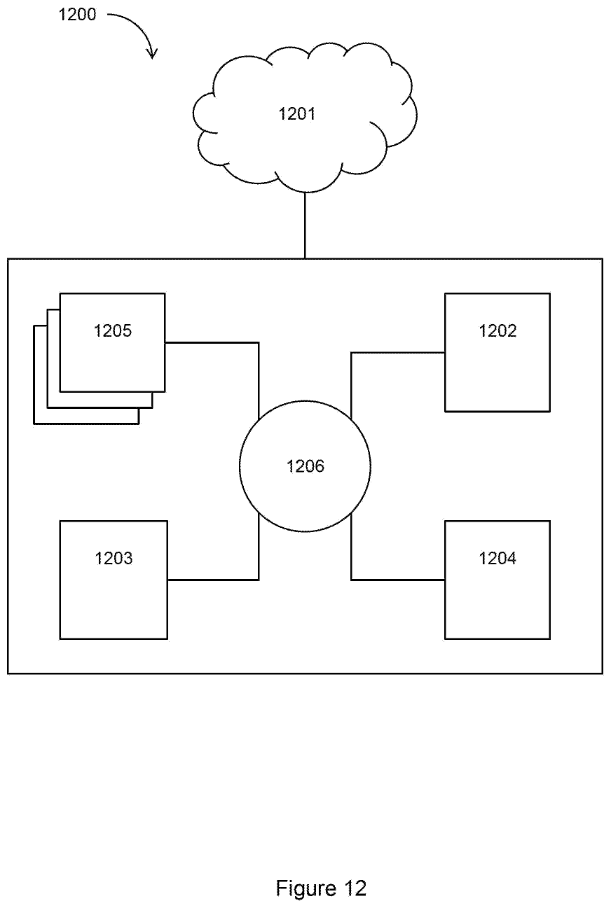

In some embodiments, the device, system, and/or apparatus disclosed herein comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor may be programmed to implement methods of the disclosure. The controller may control at least one component of the systems and/or apparatuses disclosed herein. FIG. 12 shows a schematic example of a computer system 1200 that is programmed or otherwise configured to facilitate execution any of the methods provided herein. The computer system 1200 can control (e.g., direct, monitor, and/or regulate) various features of the methods, apparatuses, devices, and/or systems of the present disclosure. The computer system 1200 can be part of, or be in communication with, the device, system and/or apparatus disclosed herein. The computer may be coupled with one or more mechanisms disclosed herein, and/or any parts thereof. The computer system 1200 can include a processing unit 1206 (also “processor,” “computer” and “computer processor” used herein). The computer system may include memory or memory location 1202 (e.g., random-access memory, read-only memory, flash memory), electronic storage unit 1204 (e.g., hard disk), communication interface 1203 (e.g., network adapter) for communicating with one or more other systems, and peripheral devices 1205, such as cache, other memory, data storage and/or electronic display adapters. The memory 1202, data storage unit 1204, interface 1203, and peripheral devices 1205 are in communication with the processing unit 1206 through a communication bus (solid lines), such as a motherboard. The storage unit can comprise a data storage unit (or data repository) for storing data. The computer system can be operatively coupled with a computer network (“network”) 1201, e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server. The processing unit can execute a sequence of machine-readable instructions, which can be embodied in a program or software. The instructions may be stored in a memory location, e.g., memory 1202. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system (e.g., 1200) can be included in the circuit.

In some embodiments, the storage unit (e.g., 1204) stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet. The processor may be configured to process control protocols, e.g., communicate with one or more components of the mechanism (e.g., device, apparatus, and/or system) disclosed herein using the control protocols. Control protocols can be one or more of the internet protocol suites, e.g., transmission control protocol (TCP) or transmission control protocol/internet protocol (TCP/IP). Control protocols can be one or more serial communication protocols. Control protocols can be one or more of controller area networks or another message-based protocol, e.g., for communication with microcontrollers and devices. Control protocols can interface with one or more serial bus interfaces for communication with the mechanism disclosed herein, e.g., with any of its components. The control protocol can be any control protocol disclosed herein.

In some embodiments, the system, device, and/or apparatus disclosed herein comprises communicating through a network. The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some embodiments, the computer system utilizes program instructions to execute, or direct execution of, operation(s). The program instructions can be inscribed in a machine executable code. Methods described herein can be implemented by way of machine (e.g., computer processor) executable code stored on an electronic storage location of the computer system, such as, for example, on the memory 1202 or electronic (e.g., data) storage unit 1204. The machine executable or machine-readable code can be provided in the form of software. During use, the processor (e.g., 1206) can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine that has a processer adapted to execute the code or can be compiled during runtime. The code can be supplied in a programming language that can be selected to enable the code to execute in a pre-compiled or as-compiled fashion.

In some embodiments, the computer system utilizes a machine-readable medium/media to execute, or direct execution of, operation(s). The program instructions can be inscribed in a machine executable code. A machine-readable medium/media, such as computer-executable code, may take many forms, including but not limited to, a tangible storage medium/media, a carrier wave medium, or physical transmission medium. Non-volatile storage media/medium include, for example, optical or magnetic disks, such as any of the processor related storage devices in any computer(s) or the like, such as may be used to implement the databases. Volatile storage media/medium can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium/media with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or data storage may comprise a storing device external to and/or removable from device, such as a Universal Serial Bus (USB) memory stick, and/or a hard disk. Many of these forms of computer readable media may be involved in carrying one or more sequences of one or more instructions to a processor for execution.

In some embodiments, the device, system, and/or apparatus disclosed herein comprises, or is operatively coupled with, a communication technology, e.g., in addition to the optical fiber disclosed herein. The communication may comprise wired or wireless communication. For example, the systems, apparatuses, and/or parts thereof may comprise Bluetooth, wi-fi, global positioning system (GPS), or radiofrequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro- or mini-USB. The surface identification mechanism may comprise a plug and/or a socket, e.g., electrical, AC power, DC power. The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

FIG. 13 shows an example of cross sections of various batteries with respect to a Cartesian coordinate system. Example 1300 shows battery cells such as cell 1302 stacked in a direction normal to the z axis, e.g., height of the battery having housing 1301. Example 1350 shows battery cell 1352 rolled upon itself about an axis normal to the drawing page, e.g., in a wound cell (e.g., jelly roll) type configuration. Battery cell 1352 is disposed (e.g. located) in battery housing 1351.

### EXAMPLE 1

In an isolated environment comprising clean dry air (CDA), rechargeable lithium ion batteries were tested at an ambient temperature of about 23 °C, and five samples were tested at 55 °C. The batteries had configuration similar to the one in FIG. 3, 300 and 350. One of the batteries (resulting in a behavior of FIG. 10, 1011) included a stacked cell configuration similar to the one in FIG. 13, 1300 or FIG. 3, 350. Each of the batteries'cells included (a) a non-dynamic insulator comprising alumina devoid of a separator type polymer, and (b) an anode being a silicon-based anode (Si—C). The silicon based anode comprised carbon. The cells of the battery being shown in FIG. 8. The other battery (resulting in a behavior of FIG. 10, 1012) included a wound cell (e.g., jelly roll) type battery similar to the one in FIG. 13, 1350, with the anode being a graphite anode. The temperature error range was +/−5 °C. The test initiated after temperature was equilibrated, between 1-4 hours, inclusively. The batteries pointed away from each other to prevent accidental shorting. A thermocouple contacted the battery housing. Batteries were attached to wires, and current was cycled through the batteries. Voltage, current, and temperature, were recorded as depicted in FIG. 10. The batteries were exposed to preconditioning charge and discharge cycles at maximum and minimum temperatures, the circuit was verified as open, the circuit resistance was verified at 80+/−20 mli-ohms, the cells were connected to an open circuit utilized for the short. The measuring conditions per temperature and voltage were established, after stabilization of the temperature, data acquisition initiated at 0.12 second intervals. The circuit closed to establish short. Temperature was monitored to detect any peaks, e.g., evidence of a thermal runaway. After a prescribed time lapsed and/or temperature threshold obtained, the circuit was opened, to stop the short and allow the cell to reach ambient temperate, e.g., within 10 °C. Without wishing to be bound to theory, the differences observed between the graphs of the stacked cell type corresponding to FIG. 10, 1011, and those corresponding to the jelly roll cell type corresponding to FIG. 10, 1012, may be due to (a) the surface area of the sides (e.g., edges) of the cell set in the stacked cell battery being substantially larger that the sides (e.g., edges) of the jelly rolled cell, (b) the number of cells in a stacked cell battery being substantially larger than in the jelly roll battery, (c) the surface area of the cathode-anode junctions on the side (e.g., edge) of the stacked cell battery being substantially larger than in the jelly roll battery, or (d) any combination thereof,

The processes discussed herein are intended to be illustrative and not limiting. One skilled in the art would appreciate that the operations (e.g., steps) of the processes discussed herein may be omitted, modified, combined, and/or rearranged, and any additional operations (e.g., steps) may be performed without departing from the scope of the invention. More generally, the above disclosure is meant to be illustrative (e.g., include examples) and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

While preferred embodiments of the present inventions have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for energy manipulation, the device comprising:
a reference electrode having a reference surface comprising a first reference face opposing to a second reference face, and a first reference side opposing to a second reference side;
a counter electrode to the reference electrode, the counter electrode having a counter surface comprising a first counter face opposing to a second counter face, and a first counter side opposing to a second counter side;
a separation space comprising a separator disposed between the reference electrode and the counter electrode, the separation space having a separation surface comprising a first separation face opposing to a second separation face and a first separation side opposing to a second separation side, the first separation face contacting the second reference face, and the second separation face contacting the first counter face; and
at least one insulator occupying an insulating volume, the at least one insulator contacting (a) the first reference side, the first counter side, and the first separation side, (b) the second reference side, the second counter side, and the second separation side, or (c) a combination of (a) and (b), the at least one insulator comprising at least one material type susceptible to a triggering event indicative of at least one adverse effect, the at least one material type being configured to alter one or more properties of the at least one material type based at least in part on occurrence of the triggering event, the at least one insulator being dynamic at least in part with respect to the triggering event, the device being configured for flow of an electrical current, the flow being between the reference electrode and the counter electrode, the at least one adverse effect being (i) to the device, (ii) to an external surrounding of the device, or (iii) a combination of (i) and (ii).

2. The device of claim 1, wherein the triggering event relates to an uncontrollable reaction resulting in the at least one adverse effect.

3. The device of claim 1, wherein the triggering event occurs at least in part in the at least one insulator, the triggering event comprising a threshold, the threshold being of an attribute comprising a temperature, electrical current flowing, or a concentration of ions.

4. The device of claim 1, wherein the triggering event comprises a melting point, or a glass transition.

5. The device of claim 1, wherein upon occurrence of the triggering event, the at least one material type is configured to transition such that the at least one adverse effect will be curtailed, become controllable, or any combination thereof, with curtailed comprising effectively ceased or measurably ceased.

6. The device of claim 1, wherein upon occurrence of the triggering event, the at least one material type is configured to transition from a harder material to a softer material.

7. The device of claim 1, wherein upon occurrence of the triggering event, the at least one material type is configured to transition comprising to connect.

8. The device of claim 1, wherein upon occurrence of the triggering event, the at least one material type is configured to transition from a softer material to a harder material.

9. The device of claim 1, wherein upon occurrence of the triggering event the at least one material type is configured to transition from a liquid to a gel.

10. The device of claim 1, wherein the at least one material type is at least one first material type; wherein the separation space comprises at least one second material type configured to curtail electrical flow through the separation space at least in part due to the triggering event occurring in the separation space; and wherein the first material type and/or the second material type, is susceptible to the triggering event.

11. The device of claim 1, wherein upon occurrence of the triggering event, (i) the first material type, (ii) the second material type, or (iii) the first material type and the second material type, is configured to transition (A) such that the at least one adverse effect will be curtailed comprising will lessen, will effectively cease, or will measurably cease, (B) such that heat generated will equate, or substantially equate, the heat generated in the device, (C) such that a propagation of ions therethrough, will be curtailed comprising will lessen, will effectively cease, or will measurably cease, (D) such that the electrical current flowing respectively therethrough, will be curtailed comprising will lessen, will effectively cease, or will measurably cease, (E) such that the electrical current flowing respectively therethrough, will be curtailed comprising will lessen, will effectively cease, or will measurably cease, (F) from a harder material to a softer material, (G) comprising to connect, (H) from a softer material to a harder material, (I) from a liquid to a gel upon occurrence of the triggering event, or (J) any combination of (A)-(I), as applicable.

12. The device of claim 1, wherein the at least one insulator is an insulator contacting (a) the first reference side, the first counter side, and the first separation side and (b) the second reference side, the second counter side, and the second separation side.

13. The device of claim 1, wherein the at least one insulator comprises a first insulator and a second insulator, the first insulator contacting (i) the first reference side, (ii) the first counter side, and (iii) the first separation side, and the second insulator contacting (a) the second reference side, (b) the second counter side, and (c) the second separation side.

14. The device of claim 1, wherein (I) the reference electrode is elongated, the reference electrode having a long axis having a first end at the first reference side opposing to a second end at the second reference side, the long axis being a length of the reference electrode, the reference electrode having a short axis having a third end at the first reference face opposing to a fourth end at the second reference face, the short axis being a width of the reference electrode, and wherein an aspect ratio of the width to the length being at least about 1:8, (II) the counter electrode is elongated, the counter electrode having the long axis having the first end at the first counter side opposing to the second end at the second counter side, the long axis being the length of the counter electrode, the counter electrode having the short axis having the third end at the first counter face opposing to the fourth end at the second counter face, the short axis being the width of the counter electrode, and wherein an aspect ratio of the width to the length being at least about 1:8, (III) wherein the separation space is elongated, the separation space having the long axis having the first end at the first counter side opposing to the second end at the second counter side, the long axis being the length of the separation space, the separation space having the short axis having the third end at the first counter face opposing to the fourth end at the second counter face, the short axis being the width of the separation space, and wherein an aspect ratio of the width to the length being at least about 1:8, or (IV) any combination of (I)-(III).

15. The device of claim 1, wherein the reference electrode comprises one or more types of metal oxide; and wherein the counter electrode comprises an allotrope of elemental carbon, or silicon.

16. The device of claim 1, wherein the device is configured such that during use of the device, a volume of an electrode and/or of the device, expands by at most about 35%, the electrode comprising the reference electrode, the counter electrode, and the separation space.

17. The device of claim 1, wherein a battery cell comprises the reference electrode, the counter electrode, and the separation space, the battery cell has a stacking axis along which faces are stacked, the faces comprising the first reference face, the first counter face, and the first separation face; and wherein the battery cell comprises cell sides, the cell sides comprising a first cell side or a second cell side, wherein each of the cell sides comprises a misalignment; wherein the first cell side comprises (i) the first reference side, (ii) the first counter side, and (iii) the first separation side; and wherein the second cell side comprises (a) the second reference side, (b) the second counter side, and (c) second first separation side.

18. The device of claim 1, wherein at least one component of the device comprises a composite material, the at least one component comprising the reference electrode, the counter electrode, the separation space, or the at least one insulator.

19. The device of claim 1, wherein a battery cell comprises the reference electrode, the counter electrode, the separation space; wherein the device is a battery comprising a cell set comprising two or more of the battery cell; wherein in the battery, each of the two or more of the battery cell are separated by a dividing space; wherein (a) the dividing space, the separation space, and the at least one insulator, have at least one material type that is the same, and (b) a partition space extends beyond (A) a reference face along a reference long axis of the reference face, the reference face comprising the first reference face or the second reference face and (B) a counter face along a counter long axis of the counter face, the counter face comprising the first counter face or the second counter face, the partition space comprising the dividing space or the separation space; wherein the partition space extends along a long axis by an extension comprising a separation extension or a divider extension, the long axis comprising the reference long axis or the counter long axis; and wherein (a) (i) the divider extension and (ii) the separation extension, are separated from each other by a gap, the divider extension and the separation extension being at a side of the battery cell, (b) the divider extension is bent towards, or is bent away from, the separation extension, (c) the divider extension is curved towards, or is curved away from, the separation extension, or (d) any combination of (a)-(c), as applicable.

20. The device of claim 19, wherein a volume disposed between the divider extension and the separation extension, comprises at least a portion of the at least one insulator.
